(19) United States
(12) Patent Application Publication
(10) Pub. No.: US 2014/0133519 A1
(43) Pub. Date: May 15, 2014

(54) EQUIPMENT AND METHODS FOR DESIGNING GEOTHERMAL HEAT EXCHANGE SYSTEMS

(71) Applicant: BRAUN INTERTEC GEOTHERMAL, LLC, MINNEAPOLIS, MN (US)

(72) Inventor: Scott Freitag, Little Falls, MN (US)

(73) Assignee: BRAUN INTERTEC GEOTHERMAL, LLC, MINNEAPOLIS,, MN (US)

(21) Appl. No.: 14/079,424

(22) Filed: Nov. 13, 2013

Related U.S. Application Data
(60) Provisional application No. 61/725,720, filed on Nov. 13, 2012.

(51) Int. Cl. G01K 1/16

(52) U.S. Cl. CPC G01K 1/16
USPC 374/165

(57) ABSTRACT

Embodiments of the present invention allow designers of geothermal heat exchange systems to closely tailor their system designs to the cooling and/or heating demands of the buildings for which their systems are being designed. Systems and methods are discussed herein for gathering information empirically about a ground heat exchanger's performance in a particular physical environment, which facilitates more accurate and efficient design of geothermal heat exchange systems. Such information can be gathered empirically from a design module connected to a ground heat exchanger in a physical environment. The design module can circulate liquid through the ground heat exchanger and conduct a variety of tests to determine characteristics of the ground heat exchanger and the physical environment.

### RELATED APPLICATION

This application claims priority to U.S. Provisional Patent Application No. 61/725,720 filed Nov. 13, 2012, the disclosure of which is hereby incorporated by reference herein in its entirety.

### TECHNICAL FIELD

The present disclosure relates to the design of geothermal heat exchange systems.

### BACKGROUND

Geothermal heat exchange systems are becoming more common and more cost effective. Traditionally, up-front costs associated with digging wells and installing equipment have served as significant impediments to the large-scale adoption of geothermal heat exchange systems. Once installed, such systems can considerably reduce ongoing energy costs, but the large up-front costs can result in long payback periods.

Geothermal heat exchange systems are often designed with the assistance of software applications. Such software applications incorporate many assumptions about the local geology, the local climate, the efficiency of the proposed equipment (including the geothermal heat exchange system itself), and so on. In many cases, one or more of these assumptions can be erroneous, and such errors can compound and lead to geothermal heat exchange system designs that are not well tailored to the actual demands of the space to be conditioned. For example, such applications do not adequately account for convective heat transfer caused by moving groundwater. In most cases, software-aided designs err on the side of including more geothermal wells than are necessary (to avoid problems associated with not providing enough cooling/heating capacity). A noteworthy drawback, however, of recommending too many geothermal wells is that the associated up-front costs often lead potential purchasers to choose other kinds of cooling/heating systems over geothermal heat exchange systems.

### SUMMARY

Embodiments of the present invention allow designers of geothermal heat exchange systems to closely tailor their system designs to the cooling and/or heating demands of the buildings for which their systems are being designed. The design process commonly starts with design specifications related to the building of interest. The design specifications can include required cooling and/or heating capacity. For example, a typical 50,000 sq. ft. office building located in a northern climate may require 1.2 million BTU/hour of cooling and 1.25 million BTU/hour of heating.

Another factor in designing geothermal heat exchange systems is the geology of the area in which the geothermal wells will reside. Some physical environments exchange heat with fluid passing through geothermal heat exchangers more efficiently than other physical environments. Some geologic formations are easier to penetrate with drilling equipment than others. For example, geologic formations that include many fractures can be more difficult to penetrate than those without such fractures because the fractures can increase the difficulty of removing material as the hole is drilled. This can result in damage to tooling and/or delay in the drilling process.

Embodiments of the present invention involve measuring design parameters (e.g., heat transfer characteristics) during the design process and making design recommendations (e.g., performing design length calculations) based on the measured parameters. For example, a ground heat exchanger bore hole can be drilled to a desired depth (e.g., 200 feet) near the building for which the geothermal heat exchange system is being designed. Within this bore hole, a ground heat exchanger (e.g., a closed loop heat exchanger (“CLHE”) or an open or closed standing column well) can be installed. In another example, the ground heat exchanger can pass partially or fully through water such that heat is exchanged with the water (e.g., separate wells for extracting from and rejecting to groundwater). In some embodiments, the ground heat exchanger can comprise surface water (e.g., a pond), and water can be extracted from and rejected to the pond. The ground heat exchanger can be installed vertically, horizontally, or at a steep angle. Ground heat exchangers can be used in a variety of physical environments.

In some instances, measurements can be taken to determine how much heat rejection capacity that particular type of ground heat exchanger provides in that particular physical environment without exceeding the maximum return water temperature set point. Set points can be selected to approximate the operating range of the planned heat pump system to be used in the system (e.g., 90° F. and 30° F.). This measurement can provide useful information for tailoring the geothermal heat exchange system to the building's cooling capacity design specifications.

In some instances, measurements can be taken to determine how much heat absorption capacity the particular type of ground heat exchanger provides in the particular physical environment without going lower than the minimum return water temperature set point. This measurement can provide useful information for tailoring the geothermal heat exchange system to the building's heating capacity design specifications.

Knowing how much heat rejection and/or how much heat absorption can be provided by a ground heat exchanger in a physical environment can make it significantly easier to determine how many of those ground heat exchangers would be required to meet design specifications. For example, if a building requires 100 tons of cooling capacity, and a CLHE provides two tons of cooling capacity in the geologic formation near the building, it can be determined that a geothermal heat exchange system for that building should include at least 50 such CLHEs. If the same building requires 35 tons of heating capacity, and the same CLHE provides one ton of heating capacity in the relevant geologic formation, it can be determined that the geothermal heat exchange system for that building should include at least 35 such CLHEs. In this example, the higher number of CLHEs would be chosen—50 rather than 35—to accommodate both cooling and heating demands.

As noted, these measurements are often taken under conditions that assume the building's heat pump is operating at its outer extremes. The building's heat pump system provides fluid (e.g., water) to the ground heat exchanger and receives fluid from the ground heat exchanger. If the heat pump is configured to receive fluid from the ground heat exchanger at a maximum temperature of, e.g., 90° F., it can be useful to know how much heat can be shed to the ground via the ground heat exchanger while providing fluid to the heat pump at 90° F. Similarly, if the heat pump is configured to receive fluid from the ground heat exchanger at a minimum temperature of, e.g., 30° F., it can be useful to know how much heat can be absorbed from the ground via the ground heat exchanger while providing fluid to the heat pump at 30° F. It is often more efficient to run the heat pump through its full operational range and to minimize the number of ground heat exchangers (and associated up-front costs) than vice versa.

### BRIEF DESCRIPTION OF FIGURES

The following figures are illustrative of particular embodiments of the present invention and therefore do not limit the scope of the invention. The figures are intended for use in conjunction with the explanations in the following detailed description. Embodiments of the present invention will hereinafter be described in conjunction with the appended figures and photographs.

FIG. 1A is a schematic diagram of an illustrative test setup according to embodiments of the present invention.

FIG. 1B is a schematic diagram of an illustrative test setup according to embodiments of the present invention.

FIG. 2A is a schematic diagram of an illustrative design module according to embodiments of the present invention.

FIG. 2B is a schematic diagram of an illustrative design module according to embodiments of the present invention.

FIG. 3 is an illustrative human-machine interface according to embodiments of the present invention.

FIG. 4 is a flow diagram of an illustrative testing sequence according to embodiments of the present invention.

FIG. 5 is a flow diagram of an illustrative testing sequence according to embodiments of the present invention.

FIG. 6 is a flow diagram of an illustrative testing sequence according to embodiments of the present invention.

FIG. 7 is a flow diagram of an illustrative testing sequence according to embodiments of the present invention.

FIG. 8 is a flow diagram of an illustrative testing sequence according to embodiments of the present invention.

FIG. 9 is a flow diagram of an illustrative testing sequence according to embodiments of the present invention.

### DETAILED DESCRIPTION OF ILLUSTRATIVE EMBODIMENTS

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

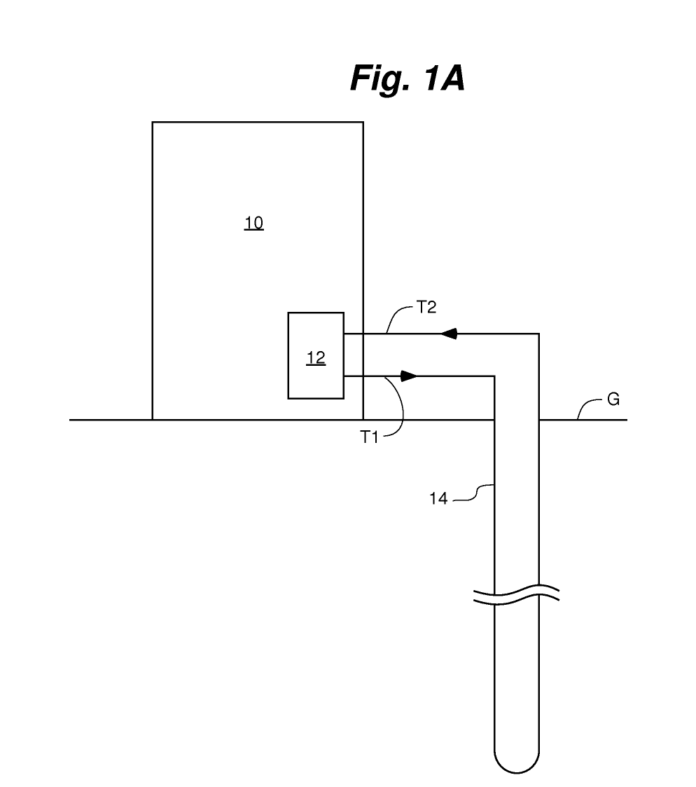

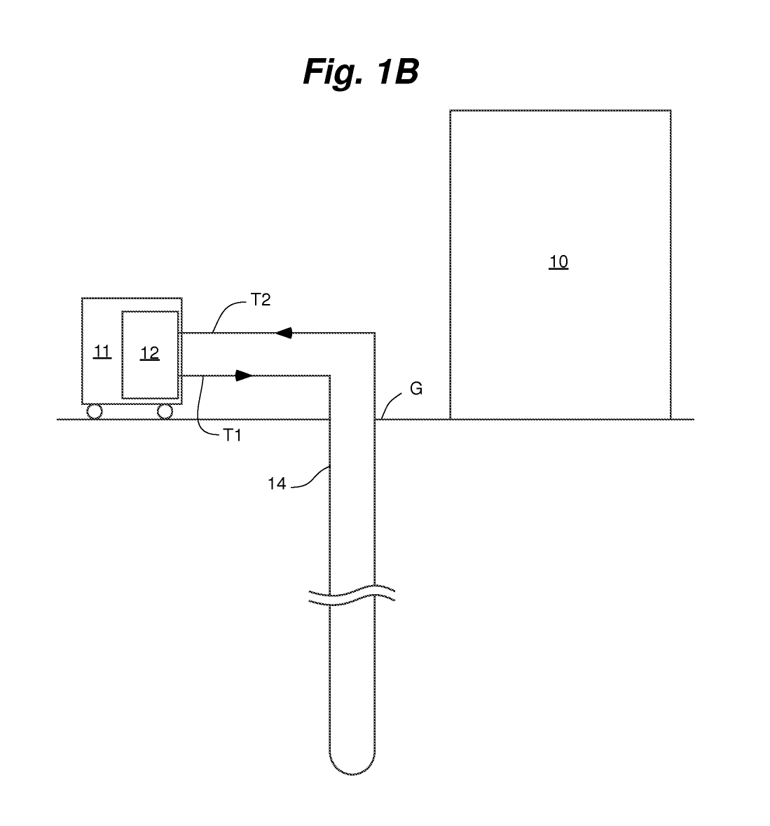

FIGS. 1A-1B show illustrative setups for implementing some of the methods discussed herein, including a building 10, a mobile unit 11, a design module 12, and a ground heat exchanger 14 that extends under the ground G. FIG. 1A shows the design module 12 in the building 10 for which the geothermal heat exchange system is being designed. FIG. 1B shows the design module 12 in the mobile unit near the building for which the geothermal heat exchange system is being designed. The design module 12 can include a controller configured to receive data from various sensors in the system and to perform selected processes based on the data. For example, the controller of the design module 12 may use the following formula to determine the heat exchange capacity of the ground heat exchanger 14:

Q=(T2−T1)*FR*C

where Q is the amount of heat exchange capacity (e.g., in tons or BTU/hour), T2 and T1 are as shown in FIG. 1, FR is the flow rate of the fluid within the ground heat exchanger, and C is a mass flow constant (usually in the range of 470-510).

In some embodiments, the mobile unit 11 of FIG. 1B can be self-contained trailer. As shown, the design module 12 inside the mobile unit 11 can be connected to the ground heat exchanger 14. In some embodiments, the mobile unit 11 can include a power generator, meaning that the design module 12 can be operated with minimal imposition to the building 10 for which the geothermal heat exchange system is being designed. In some instances, when the design process is completed, the design module 12 can be disconnected from the test ground heat exchanger 14, and the test ground heat exchanger 14 can be incorporated into the designed system.

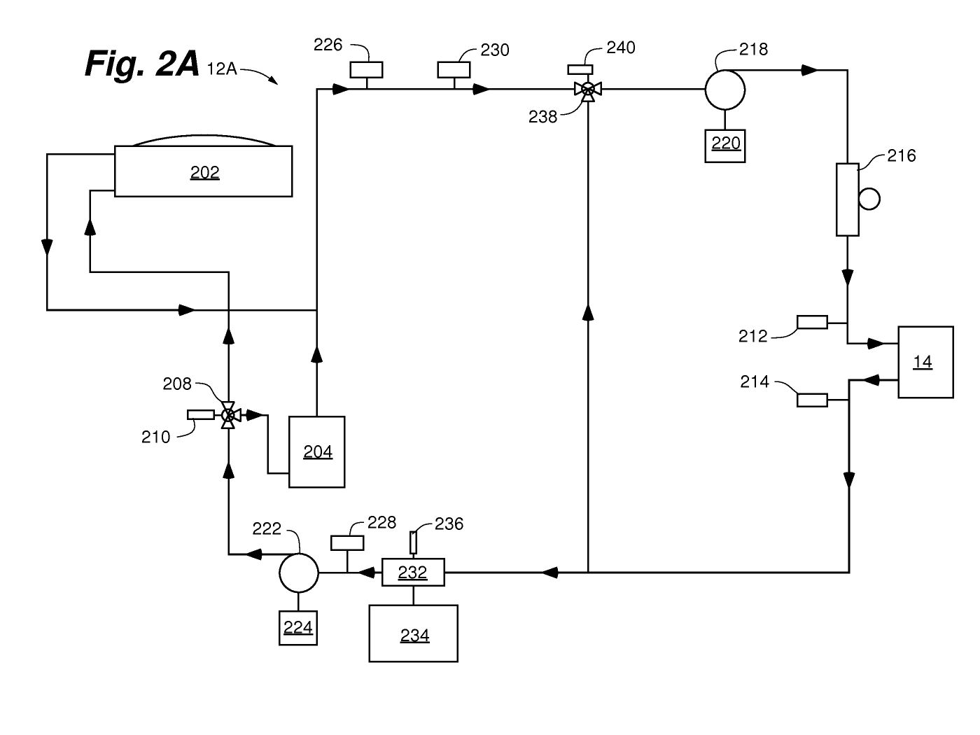

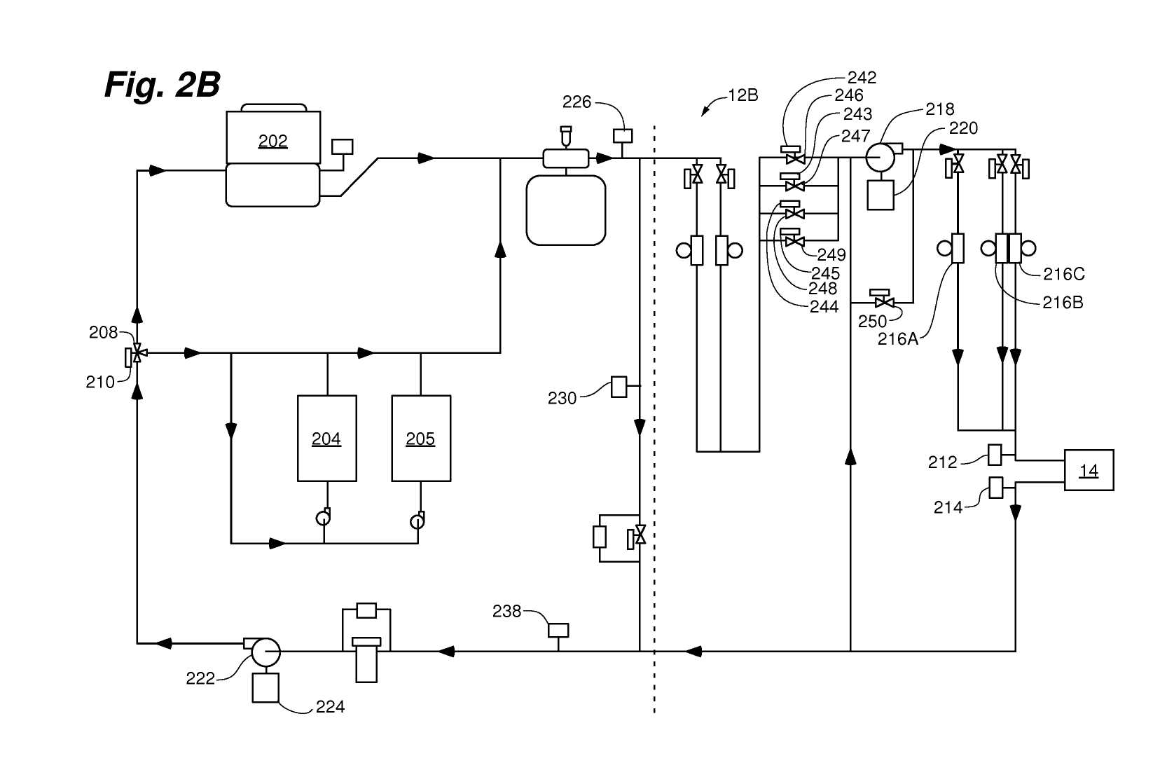

A variety of design modules can be used in connection with systems and methods discussed herein. For example, a design module can be provided for collecting information to be used in designing a geothermal heat exchange system. In some embodiments, the design module can include a source loop that is connected to heating equipment (e.g., one or more boilers) and cooling equipment (e.g., one or more chillers). The source loop can include a source liquid temperature sensor. In some embodiments, the design module can include a load loop that is connected to a ground heat exchanger (e.g., those discussed herein) in a physical environment. The load loop can include an input liquid temperature sensor and a return liquid temperature sensor. In some embodiments, the design module can include a mixing valve (e.g., a proportioning valve, one or more injection valves, etc.) that is connected to the source loop and the load loop. The mixing valve can be configured to mix source liquid from the source loop with return liquid from the ground heat exchanger (e.g., 50% source liquid and 50% return liquid, 100% source liquid and 0% return liquid, 0% source liquid and 100% return liquid, etc.). For example, the injection valves 246, 247, 248, 249 of FIG. 2B can each have different sizes and/or accommodate different flow volumes such that opening and closing them provides a wide range of injection flexibility. The mixing valve can be configured to supply input liquid to the ground heat exchanger. Design modules having these or similar attributes can be configured to perform several or all of the tests discussed herein (e.g., heat rejection capacity, thermal recovery, heat absorption capacity, etc.) to collect information to be used in designing a geothermal heat exchange system.

In many embodiments, the design module can include a control system for controlling other components of the design module. The control system can include a testing controller that conducts various tests to collect information for designing geothermal heat exchange systems. The control system can include a source loop controller to control components in the source loop. For example, the source loop controller can be configured to selectively activate the heating equipment or the cooling equipment (which includes deactivating both the heating equipment and the cooling equipment). The source loop controller can be configured to receive a source liquid temperature value from the source liquid temperature sensor. In some embodiments, the source loop controller can be configured to adjust operation of the heating equipment or the cooling equipment to conform the source liquid temperature value to a source liquid temperature set point. Some design module control systems can include a mixing valve controller for controlling the mixing valve. The mixing valve controller can be configured to receive the source liquid temperature value from the source liquid temperature sensor. In some embodiments, the mixing valve controller can be configured to receive a return liquid temperature value from the return liquid temperature sensor. The mixing valve controller can be configured to adjust the mixing valve to supply input liquid to the ground heat exchanger. The controllers shown in FIGS. 2A-2B—controller 210; controller 220; controller 224; controller 240; controllers 242, 243, 244, 245; etc.—can be part of the control system.

Some design modules can vary the flow rate of liquid flowing through the source loop and/or the load loop. The source loop or the load loop (or both) can include a variable speed pump. In some embodiments, the source loop controller can be configured to adjust operation of the source loop's variable speed pump to conform the source liquid's flow rate value to a set point. In some such embodiments, the testing controller can determine the source liquid flow rate set point in conjunction with the source liquid temperature set point to ensure that source liquid with predetermined temperature-adjustment attributes is provided to the mixing valve. In some embodiments, the design module can include a load loop controller, which can be configured to adjust operation of the load loop's variable speed pump to conform the load liquid's flow rate value to a set point.

In some preferred embodiments, T1 or T2, FR, and C can be held generally constant, and T1 or T2—whichever is not held constant—can be measured to determine Q. In particularly preferred embodiments, T1 can be held constant, and T2 can be measured. FIGS. 2A-2B show illustrative design modules 12A, 12B for implementing embodiments discussed herein. The design module 12A of FIG. 2A can include a chiller 202 and a boiler 204. The design module 12B of FIG. 2B can likewise include a chiller 202, along with two boilers 204, 205. Referring to FIGS. 2A-2B, a control valve 208, controlled by a controller 210, can activate either the chiller 202 or the boiler(s) 204, 205, depending on the test being performed by the design module 12A, 12B. If the design module 12A, 12B is performing a heat absorption test, such as is described elsewhere herein, the control valve 208 may activate the chiller 202. If the design module 12A, 12B is performing a heat rejection test, such as is described elsewhere herein, the control valve 208 may activate the boiler(s) 204, 205.

Temperature sensors 212 and 214 may be configured to measure, respectively, the ground heat exchanger inlet temperature—T1 in FIGS. 1A-1B—and the ground heat exchanger outlet temperature—T2 in FIGS. 1A-1B. In some embodiments, temperature sensors 212, 214 may be scientific grade sensors. Similarly, flow meter 216, which may be configured to measure the flow rate of liquid flowing through the flow meter(s) 216, 216A, 216B, 216C may be of scientific grade. In some embodiments, the temperature sensors 212, 214 and the flow meter(s) 216, 216A, 216B, 216C may provide temperature values and flow rate values, respectively, to within 6% accuracy. These values can be used by the design module's controller in the heat exchange capacity equation provided above.

The design module 12A, 12B can include a variety of components for circulating fluid (e.g., water) through the chiller 202 or boiler(s) 204, 205 and the ground heat exchanger 14. A load loop pump 218 can be controlled by a controller 220 and can circulate fluid from the chiller 202 or the boiler 204 to the ground heat exchanger 14. A source loop pump 222 can be controlled by a controller 224 and can circulate fluid from the ground heat exchanger 14 back to the chiller 202 or the boiler 204. Source loop temperature sensor 226 and load loop temperature sensor 228 can sense temperature at their respective locations in the design module 12A, 12B. Pressure sensor 230 can measure the pressure of fluid in the design module 12A, 12B. In some embodiments, the source loop temperature sensor 226 and/or the load loop temperature sensor 228 and/or the pressure sensor 230 may be ordinary, non-scientific grade sensors. A sediment filter and air vent 232, 236 and/or an expansion tank 234 can be incorporated into the design module 12A.

Referring to FIGS. 1A, 1B, 2A, 2B, as noted, in some preferred embodiments, the temperature of the fluid entering the ground heat exchanger 14—T1 as shown—or the temperature of fluid returning from the ground heat exchanger 14—T2 as shown—can be maintained at a generally constant value. In the design module 12A of FIG. 2A, temperature sensor 212 measures T1, and temperature sensor 214 measures T2. Proportioning valve 238, which may be controlled by controller 240, can play an important role in the design module 12A maintaining T1 or T2 at a generally constant value. As shown, proportioning valve 238 may receive fluid from the source loop and from the return of the ground heat exchanger 14. Fluid received from the source loop is commonly at a different temperature than return fluid received from the ground heat exchanger 14. Controller 240 may cause proportioning valve 238 to supply the right mixture of those two fluid inputs to ensure that the temperature of the fluid provided to the ground heat exchanger 14—T1 as shown—is at the desired generally constant value or results in T2 being maintained at the desired generally constant value. T1 can be measured periodically by temperature sensor 212, and/or T2 can be measured periodically by temperature sensor 214, and the heat exchange capacity of the ground heat exchanger 14 can be likewise calculated periodically. In some embodiments, the proportioning valve 238 may be controlled manually.

In the design module 12B of FIG. 2B, injection valves 246, 247, 248, 249 can plan an important role in the design module 12B maintaining the input temperature or the return temperature at a generally constant value. As shown, return fluid can flow from the ground heat exchanger 14 either through the load loop pump 218 or valve 250 or through the source loop pump 222. Return liquid that flows through load loop pump 218 or valve 250 can be mixed with source liquid coming through injection valves 246, 247, 248, 249. Again, fluid received from the source loop is commonly at a different temperature than return fluid received from the ground heat exchanger 14. Controllers 242, 243, 244, 245 may cause injection valves 246, 247, 248, 249, respectively, to supply the right mixture of those two fluid inputs to ensure that the temperature of the fluid provided to the ground heat exchanger 14-T1 as shown—is at the desired generally constant value or results in T2 being maintained at the desired generally constant value. T1 can be measured periodically by temperature sensor 212, and/or T2 can be measured periodically by temperature sensor 214, and the heat exchange capacity of the ground heat exchanger 14 can be likewise calculated periodically. In some embodiments, the injection valves 246, 247, 248, 249 may be controlled manually.

Referring again to FIGS. 2A-2B, when the design module 12A, 12B is testing the heat absorption capacity of the ground heat exchanger 14, controller 210 can cause control valve 208 to activate the chiller 202. In some embodiments, the chiller 202 can be configured to supply fluid to the proportioning valve 238 or to the injection valves 246, 247, 248, 249 at a temperature that is lower than an estimated value of T1 required to maintain T2 at its desired value. For example, if T2 is to be maintained at 30° F., T1 may be estimated at approximately 25° F., and the fluid supplied by the chiller 202 to the proportioning valve 238 or to the injection valves 246, 247, 248, 249 may be between 15° F. and 30° F. (e.g., between 20° F. and 25° F.). The return fluid supplied to the proportioning valve 238 or to load loop pump 218 or valve 250 is typically at a temperature very similar to T2. A mixing valve controller (e.g., a controller that controls controller 240 or controllers 242, 243, 244, 245) can receive temperature data from temperature sensors 214 and 226 and can cause the proportioning valve 238 or the injection valves 246, 247, 248, 249 to adjust the mixture of source fluid and return fluid to maintain T2 generally constant at 30° F. Temperature sensor 212 can measure T1, and the heat absorption capacity of the ground heat exchanger 14 can be calculated.

In some embodiments, the chiller 202 can be configured to supply fluid to the proportioning valve 238 or to the injection valves 246, 247, 248, 249 at a temperature that is lower than a desired value of T1. For example, if T1 is to be maintained at 30° F., the fluid supplied by the chiller 202 to the proportioning valve 238 or to the injection valves 246, 247, 248, 249 may be between 15° F. and 30° F. (e.g., between 20° F. and 25° F.). The return fluid supplied to the proportioning valve 238 or to load loop pump 218 or valve 250 is typically at a temperature very similar to T2, which is typically warmer than T1. A mixing valve controller (e.g., a controller that controls controller 240 or controllers 242, 243, 244, 245) can receive temperature data from temperature sensors 214 and 226 and can cause the proportioning valve 238 or the injection valves 246, 247, 248, 249 to adjust the mixture of source fluid and return fluid to maintain T1 generally constant at 30° F. Temperature sensor 214 can measure T2, and the heat absorption capacity of the ground heat exchanger 14 can be calculated.

When the design module 12A, 12B is testing the heat rejection capacity of the ground heat exchanger 14, controller 210 can cause control valve 208 to activate the boiler(s) 204, 205. In some embodiments, the boiler(s) 204, 205 can be configured to supply fluid to the proportioning valve 238 or to the injection valves 246, 247, 248, 249 at a temperature that is higher than an estimated value of T1 required to maintain T2 at its desired value. For example, if T2 is to be maintained at 90° F., T1 may be estimated at approximately 100° F. to 115° F., and the fluid supplied by the boiler 204 to the proportioning valve 238 or to the injection valves 246, 247, 248, 249 may be between 95° F. and 150° F. (e.g., between 105° F. and 120° F.). As noted, the fluid supplied to the proportioning valve 238 or to load loop pump 218 or valve 250 is typically at a temperature very similar to T2. A mixing valve controller (e.g., a controller that controls controller 240 or controllers 242, 243, 244, 245) can receive temperature data from temperature sensors 214 and 226 and can cause the proportioning valve 238 or the injection valves 246, 247, 248, 249 to adjust the mixture of source fluid and return fluid to maintain T2 generally constant at 90° F. Temperature sensor 212 can measure T1, and the heat rejection capacity of the ground heat exchanger 14 can be calculated.

In some embodiments, the boiler(s) 204, 205 can be configured to supply fluid to the proportioning valve 238 or to the injection valves 246, 247, 248, 249 at a temperature that is higher than a desired value of T1. For example, if T1 is to be maintained at 90° F., the fluid supplied by the boiler(s) 204, 205 to the proportioning valve 238 or to the injection valves 246, 247, 248, 249 may be between 95° F. and 150° F. (e.g., between 105° F. and 120° F.). The return fluid supplied to the proportioning valve 238 or to load loop pump 218 or valve 250 is typically at a temperature very similar to T2, which is typically cooler than T1. A mixing valve controller (e.g., a controller that controls controller 240 or controllers 242, 243, 244, 245) can receive temperature data from temperature sensors 214 and 226 and can cause the proportioning valve 238 or the injection valves 246, 247, 248, 249 to adjust the mixture of source fluid and return fluid to maintain T1 generally constant at 90° F. Temperature sensor 214 can measure T2, and the heat absorption capacity of the ground heat exchanger 14 can be calculated.

When the ground heat exchanger 14 exchanges heat with the ground, the temperature of the ground in proximity to the ground heat exchanger 14 typically changes. When the ground heat exchanger 14 absorbs heat from the ground, the temperature of the ground in proximity to the ground heat exchanger 14 typically decreases. When the ground heat exchanger 14 rejects heat to the ground, the temperature of the ground in proximity to the ground heat exchanger 14 typically increases.

These changes to the ground temperature can have a considerable impact the heat exchange capacity of the ground heat exchanger 14. As heat is absorbed from the ground, the heat absorption capacity of the ground heat exchanger 14 generally decreases. As heat is rejected to the ground, the heat rejection capacity of the ground heat exchanger 214 generally decreases.

Such changes to the ground temperature are typically temporary. After the temperature of the ground in proximity to the ground heat exchanger 14 decreases in connection with a heat absorption operation, this part of the ground is able to pick up heat from the surrounding physical environment, thereby restoring the temperature of the ground to its typical value. After the temperature of the ground in proximity to the ground heat exchanger 14 increases in connection with a heat rejection operation, this part of the ground is able to shed heat to the surrounding physical environment, thereby restoring the temperature of the ground to its typical value. In other words, such changes to ground temperature in proximity to the ground heat exchanger 14 are distributed more broadly across the physical environment over time, thereby “recharging” the ground.

Embodiments of the present invention can account for the gradual changes to the ground temperature in calculating heat exchange capacity. In some embodiments, the design module 12 can calculate the heat exchange capacity of the ground heat exchanger 14 in real time over an extended period of time. For example, in some embodiments, heat exchange capacity can be measured every six seconds over an eight-hour period. Real-time understanding of the heat exchange capacity of a ground heat exchanger 14 can be beneficial in closely tailoring a geothermal heat exchange system design to the cooling and/or heating demands of the building for which the system is being designed.

In some instances, it can be useful to know how long the ground near the ground heat exchanger 14 takes to recharge or recover. Referring to FIGS. 2A-2B, after the design module 12A, 12B completes a heat absorption or heat rejection test, the chiller 202 or boiler(s) 204, 205 can be deactivated. Temperature sensor 214 can continue to monitor T2 until T2 returns to the normal ground temperature. The time from when the chiller 202 or boiler 204 are deactivated to when T2 approximates the normal ground temperature can be measured, and this time measurement can be used in designing a geothermal heat exchange system.

In some situations, one or more supplemental heat exchangers can be incorporated into a geothermal heat exchange system to reduce the amount of time required for the ground to recharge. Examples of supplemental heat exchangers can include a cooling tower, a fluid cooler, and so on.

In some embodiments, the design module 12A, 12B can be configured to simulate the presence of one or more supplemental heat exchangers. For example, after a heat rejection test, after deactivation of the boiler(s) 204, 205, the chiller 202 can be activated. The mixing valve (e.g., proportioning valve 238; injection valves 246, 247, 248, 249; etc.) can supply fluid to the ground heat exchanger 14 in conditions that simulate the fluid having passed through a cooling tower or fluid cooler. This can approximate how the addition of a supplemental heat exchanger impacts ground recharge or recovery time. Information regarding how various supplemental heat exchangers impact ground recharge or recovery time can be used to make decisions regarding incorporating such heat exchangers in designing a geothermal heat exchange system.

In some embodiments, two or more of the tests discussed herein can be run sequentially with automatic transitions between the tests. For example, in some embodiments, after a heat absorption capacity test is run, automated controls can trigger measurement of the time for the ground near the ground heat exchanger to recharge or recover. In some such embodiments, measurement of the time for the ground near the ground heat exchanger to recover can involve collecting data on the rate of ground recovery and using that data to estimate the total ground recovery capability. In some such embodiments, after collecting data on the rate of ground recovery, automated controls can trigger measurement of how one or more supplemental heat exchangers impacts ground recharge time (e.g., by using the fluid cooler to simulate the supplemental heat exchanger(s) and collecting data on the supplemented rate of ground recharging). In some embodiments, after a heat absorption capacity test and/or a thermal recovery test and/or a supplemented ground recharge test are run, automated controls can trigger a heat rejection capacity test and/or a ground recharge test and/or a supplemented ground recharge test. Some embodiments involve combinations of the following six tests in various sequences with automated and/or manual transitions:
a heat absorption capacity test;
a ground recharge test—the time required for cooled ground to heat back up to its normal temperature;
a supplemented ground recharge test—the time required for cooled ground to heat back up to its normal temperature, as supplemented by one or more supplemental heat exchangers;
a heat rejection capacity test;
a ground recharge test—the time required for warmed ground to cool back down to its normal temperature; and
a supplemented ground recharge test—the time required for warmed ground to cool back down to its normal temperature, as supplemented by one or more supplemental heat exchangers.
   Such tests may be conducted by the design module 12A, 12B shown in FIGS. 2A, 2B or by other design modules suitable for conducting such tests. Other tests may be conducted to gather additional information that is useful in designing geothermal heat exchange systems. For example, in some instances, the design module may simulate a “worst case scenario” for building heating/cooling demands, gauge the heat exchange capacity of the ground heat exchanger during the test, and incorporate information gathered in this simulation into the design of the geothermal heat exchange system.

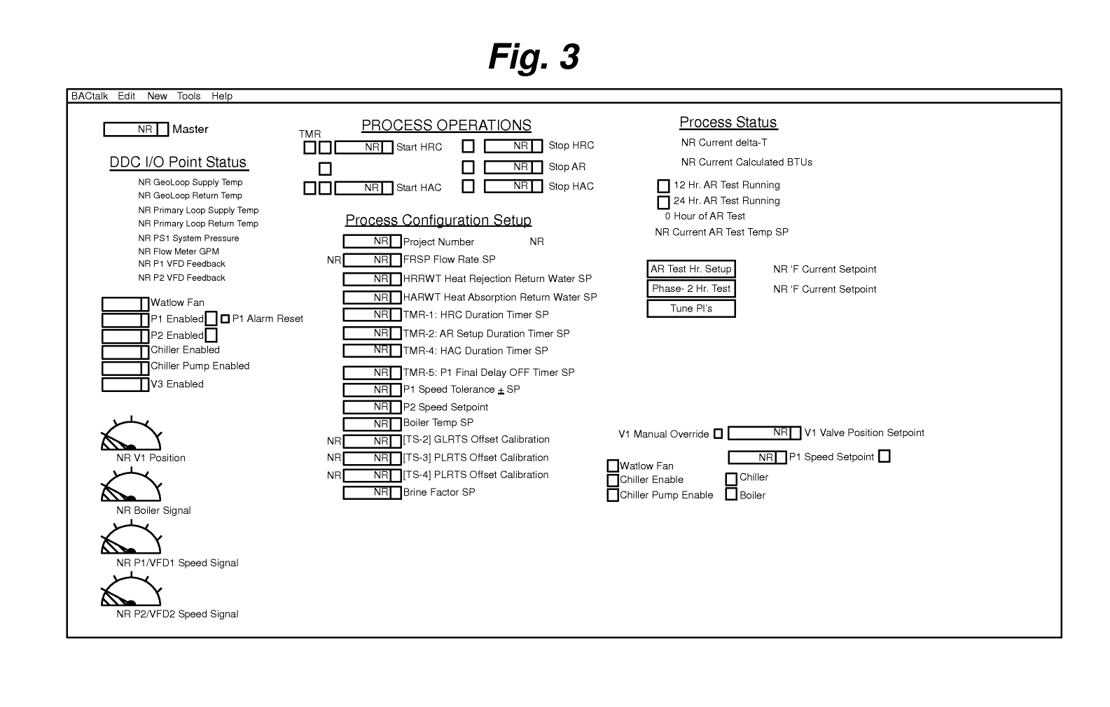

Some design modules can include a human-machine interface configured to display information to a user and to permit the user to access the control system. For example, some human-machine interfaces can display information related to the ground heat exchanger and/or the physical environment (e.g., in real time during testing). Some human-machine interfaces can permit the user to manually control components of the design module (e.g., activate/deactivate heating/cooling equipment, adjust variable speed pumps, etc.). Some human-machine interfaces can permit the user to program controls into the design module's control system (e.g., set one or more liquid temperature set points, set one or more flow rate set points, select one or more tests to be conducted by the testing controller, determine a sequence of tests to be conducted by the testing controller, specify a time duration for one or more tests to be conducted by the testing controller, etc.). FIG. 3 shows an illustrative human-machine interface that may be used in connection with design module embodiments.

Automatic administration of tests discussed herein and automatic transition between such tests can provide a variety of advantages. For example, the automation can reduce the incidence of human operator error. In many embodiments, such automation can provide increased efficiency in testing. For example, a geothermal heat exchange system design team may spend 2-3 days drilling a bore hole, installing a test ground heat exchanger, and connecting a design module, and then follow that up with 2-7 days of automated tests with the design module. In this way, the entire empirical assessment can be completed in less than two weeks, which can accelerate the process of getting the designed system installed.

Some design modules according to embodiments of the present invention can be used to measure the excess heat exchange capacity of existing geothermal heat exchange systems. For example, if a secondary school has a geothermal heat exchange system, and a school district is trying to decide whether to locate an elementary school next to the secondary school, an important factor may be whether the elementary school would be able to use any excess heat exchange capacity from the secondary school's geothermal heat exchange system. The design module may be connected to the existing geothermal heat exchange system, and one or more of the tests discussed herein may be conducted. The results of the test(s) may be compared to the heat exchange capacity requirements of the secondary school and the elementary school, and useful information may be discerned regarding any excess capacity.

As discussed, systems and methods are provided herein for gathering information empirically about a ground heat exchanger's performance in a particular physical environment, which facilitates more accurate and efficient design of geothermal heat exchange systems. Such information can be gathered empirically from a design module (e.g., those discussed herein) connected to a ground heat exchanger in a physical environment (e.g., installed in a bore hole in a geologic formation). The design module can circulate liquid through the ground heat exchanger, with the liquid having an input temperature entering the ground heat exchanger and a return temperature returning from the ground heat exchanger.

As discussed herein, the design module can be configured to conduct a variety of tests. For example, the design module can conduct a heat rejection capacity test to determine heat rejection characteristics of the ground heat exchanger in the physical environment (e.g., how many units of heat energy per unit time the ground heat exchanger can reject to the physical environment). In another example, the design module can conduct a heat absorption capacity test to determine heat absorption characteristics of the ground heat exchanger in the physical environment (e.g., how many units of heat energy per unit time the ground heat exchanger can absorb from the physical environment). In yet another example, the design module can conduct a thermal recovery test to determine thermal recovery characteristics of the physical environment.

In some preferred embodiments, the design module can conduct the thermal recovery test between conducting the heat rejection capacity test and conducting the heat absorption capacity test. In some such embodiments, the design module can conduct the heat rejection capacity test before conducting the thermal recovery test. In some such embodiments, the design module can conduct the heat absorption capacity test before conducting the thermal recovery test.

In some embodiments, the design module can display results of the various tests it conducts. For example, the design module can display heat rejection characteristics and/or heat absorption characteristics of the ground heat exchanger in the physical environment. In another example, the design module can display thermal recovery characteristics of the physical environment. In some preferred embodiments, both the displaying of heat rejection characteristics and heat absorption characteristics of the ground heat exchanger in the physical environment and the displaying of thermal recovery characteristics of the physical environment are in real time.

As noted, the design module's heat rejection capacity test can produce information that helps determine heat rejection characteristics of the ground heat exchanger in the physical environment. In some embodiments, the heat rejection capacity test can include circulating the liquid through the ground heat exchanger at a first flow rate. The liquid's input temperature or return temperature can be held at a first temperature level that is above a ground equilibrium temperature. Whichever of the liquid's input temperature or return temperature is not being held at the first temperature level can be measured. In many preferred embodiments, the liquid's input temperature is held at the first temperature level, and the liquid's return temperature is measured. The liquid's input temperature and return temperature can be compared over time to determine heat rejection characteristics of the ground heat exchanger in the physical environment.

Embodiments of the heat rejection capacity test involve circulating the liquid through the ground heat exchanger at a variety of flow rates to determine which flow rate provides greatest heat rejection capacity. For example, the heat rejection capacity test can include circulating the liquid through the ground heat exchanger at a second flow rate that differs from the first flow rate. At that second flow rate, the liquid's input/return temperature can be held at the first temperature level, and the return/input temperature can be measured. The liquid's input temperature and return temperature can be compared over time to determine heat rejection characteristics of the ground heat exchanger in the physical environment (e.g., does the first flow rate or the second flow rate provide greater heat rejection capacity with the liquid's input temperature or return temperature at the first temperature level?). This can be done at two flow rates, three flow rates, four flow rates, or any suitable number of flow rates. In many preferred embodiments, the heat rejection capacity test includes comparing the liquid's input temperature and return temperature at two or more liquid flow rates and an input temperature level above a ground equilibrium temperature. In such embodiments, the comparison can be used to determine which of the two or more liquid flow rates provides greatest heat rejection capacity at the input temperature level.

Embodiments of the heat rejection capacity test involve changing the liquid's input/return temperature to a variety of levels above the ground equilibrium temperature to simulate various cooling loads demanded by the building for which the geothermal heat exchange system is being designed. Some such embodiments involve changing the liquid's input/return temperature to a second temperature level that is above the ground equilibrium temperature and differs from the first temperature level. Some such embodiments involve holding the liquid's input/return temperature at the second temperature level and measuring the liquid's return/input temperature. The liquid's input temperature and return temperature can be compared over time to determine heat rejection characteristics of the ground heat exchanger in the physical environment. This can be done at two constant temperature values, three constant temperature values, four constant temperature values, or any suitable number of constant temperature values.

Some preferred embodiments can involve both varying the flow rate and the input temperature level to determine which flow rate provides the greatest heat rejection capacity at various input temperature levels. For example, the liquid can be circulated through the ground heat exchanger at a second flow rate that differs from the first flow rate after comparing the liquid's input temperature and return temperature but before changing the liquid's input/return temperature. Then, at the second flow rate, another comparison can be made of the liquid's input temperature and return temperature over time to determine heat rejection characteristics of the ground heat exchanger in the physical environment. In some preferred embodiments, this changing of flow rates can occur at each input temperature level. The heat rejection capacity test can include comparing the liquid's input temperature and return temperature at three or more liquid flow rates and three or more input temperature levels. In some such embodiments, each input temperature level can be above the ground equilibrium temperature.

In many embodiments, such as those discussed in the immediately preceding paragraphs, the design module's heat rejection capacity test can include conducting an additional heat rejection capacity test. The additional heat rejection capacity test can include comparing the liquid's input temperature and return temperature at the input temperature level and at whichever liquid flow rate is determined to provide greatest heat rejection capacity at the input temperature level. The additional heat rejection capacity test can facilitate determination of additional heat rejection characteristics of the ground heat exchanger in the physical environment. In many embodiments, the rate of change of the difference between the input and return temperatures can be measured in such an additional heat rejection capacity test by measuring and comparing the temperatures over a relatively long period of time.

As noted, the design module's heat absorption capacity test can produce information that helps determine heat absorption characteristics of the ground heat exchanger in the physical environment. In some embodiments, the heat absorption capacity test can include circulating the liquid through the ground heat exchanger at a first flow rate. The liquid's input temperature or return temperature can be held at a first temperature level that is below a ground equilibrium temperature. Whichever of the liquid's input temperature or return temperature is not being held at the first temperature level can be measured. In many preferred embodiments, the liquid's input temperature is held at the first temperature level, and the liquid's return temperature is measured. The liquid's input temperature and return temperature can be compared over time to determine heat absorption characteristics of the ground heat exchanger in the physical environment.

Embodiments of the heat absorption capacity test involve circulating the liquid through the ground heat exchanger at a variety of flow rates to determine which flow rate provides greatest heat absorption capacity. For example, the heat absorption capacity test can include circulating the liquid through the ground heat exchanger at a second flow rate that differs from the first flow rate. At that second flow rate, the liquid's input/return temperature can be held at the first temperature level, and the return/input temperature can be measured. The liquid's input temperature and return temperature can be compared over time to determine heat absorption characteristics of the ground heat exchanger in the physical environment (e.g., does the first flow rate or the second flow rate provide greater heat absorption capacity with the liquid's input temperature or return temperature at the first temperature level?). This can be done at two flow rates, three flow rates, four flow rates, or any suitable number of flow rates. In many preferred embodiments, the heat absorption capacity test includes comparing the liquid's input temperature and return temperature at two or more liquid flow rates and an input temperature level below a ground equilibrium temperature. In such embodiments, the comparison can be used to determine which of the two or more liquid flow rates provides greatest heat absorption capacity at the input temperature level.

Embodiments of the heat absorption capacity test involve changing the liquid's input/return temperature to a variety of levels below the ground equilibrium temperature to simulate various cooling loads demanded by the building for which the geothermal heat exchange system is being designed. Some such embodiments involve changing the liquid's input/return temperature to a second temperature level that is below the ground equilibrium temperature and differs from the first temperature level. Some such embodiments involve holding the liquid's input/return temperature at the second temperature level and measuring the liquid's return/input temperature. The liquid's input temperature and return temperature can be compared over time to determine heat absorption characteristics of the ground heat exchanger in the physical environment. This can be done at two constant temperature values, three constant temperature values, four constant temperature values, or any suitable number of constant temperature values.

Some preferred embodiments can involve both varying the flow rate and the input temperature level to determine which flow rate provides the greatest heat absorption capacity at various input temperature levels. For example, the liquid can be circulated through the ground heat exchanger at a second flow rate that differs from the first flow rate after comparing the liquid's input temperature and return temperature but before changing the liquid's input/return temperature. Then, at the second flow rate, another comparison can be made of the liquid's input temperature and return temperature over time to determine heat absorption characteristics of the ground heat exchanger in the physical environment. In some preferred embodiments, this changing of flow rates can occur at each input temperature level or constant temperature value. The heat absorption capacity test can include comparing the liquid's input temperature and return temperature at three or more liquid flow rates and three or more input temperature levels. In some such embodiments, each input temperature level can be below the ground equilibrium temperature.

In many embodiments, such as those discussed in the immediately preceding paragraphs, the design module's heat absorption capacity test can include conducting an additional heat absorption capacity test. The additional heat absorption capacity test can include comparing the liquid's input temperature and return temperature at the input temperature level and at whichever liquid flow rate is determined to provide greatest heat absorption capacity at the input temperature level. The additional heat absorption capacity test can facilitate determination of additional heat absorption characteristics of the ground heat exchanger in the physical environment. As with the additional heat rejection capacity tests discussed herein, in many embodiments, the rate of change of the difference between the input and return temperatures can be measured in such an additional heat absorption capacity test by measuring and comparing the temperatures over a relatively long period of time.

As noted, the design module's thermal recovery test can produce information that helps determine thermal recovery characteristics of the physical environment. In some embodiments, the design module neither adds heat to the liquid nor removes heat from the liquid. This kind of thermal recovery test can be called a hydrogeologic recovery test. In some embodiments, the design module removes heat from the liquid in a manner that simulates a supplemental heat exchanger. This kind of thermal recovery test can be called an atmospheric recovery test. In many thermal recovery tests, the design module can measure a length of time for the input temperature and the return temperature to approximate the ground equilibrium temperature.

In some embodiments, the design module can conduct a heat rejection capacity test and a heat absorption capacity test (e.g., in a manner such as discussed herein) to identify liquid flow rates that, respectively, provide greatest heat rejection capacity at a raised temperature input level and greatest heat absorption capacity at a lowered input temperature level. The liquid flow rate that provides greatest heat rejection capacity at the raised temperature input level can be selected from among a first set of liquid flow rates. The liquid flow rate that provides greatest heat absorption capacity at the lowered temperature input level can be selected from among a second set of liquid flow rates. In many preferred embodiments, the design module can conduct an additional heat rejection capacity test (such as those discussed elsewhere herein) at the liquid flow rate that provides greatest heat rejection capacity at the raised temperature input level. In some such embodiments, the design module can conduct an additional thermal recovery test after conducting the heat rejection capacity test but before conducting the additional heat rejection capacity test. In many preferred embodiments, the design module can conduct an additional heat absorption capacity test (such as those discussed elsewhere herein) at the liquid flow rate that provides greatest heat absorption capacity at the lowered temperature input level. In some such embodiments, the design module can conduct an additional thermal recovery test after conducting the heat absorption capacity test but before conducting the additional heat absorption capacity test. In some embodiments, the design module's test sequence is heat rejection capacity test, hydrogeologic recovery test, additional heat rejection capacity test, atmospheric recovery test, heat absorption capacity test, hydrogeologic recovery test, and additional heat absorption capacity test.

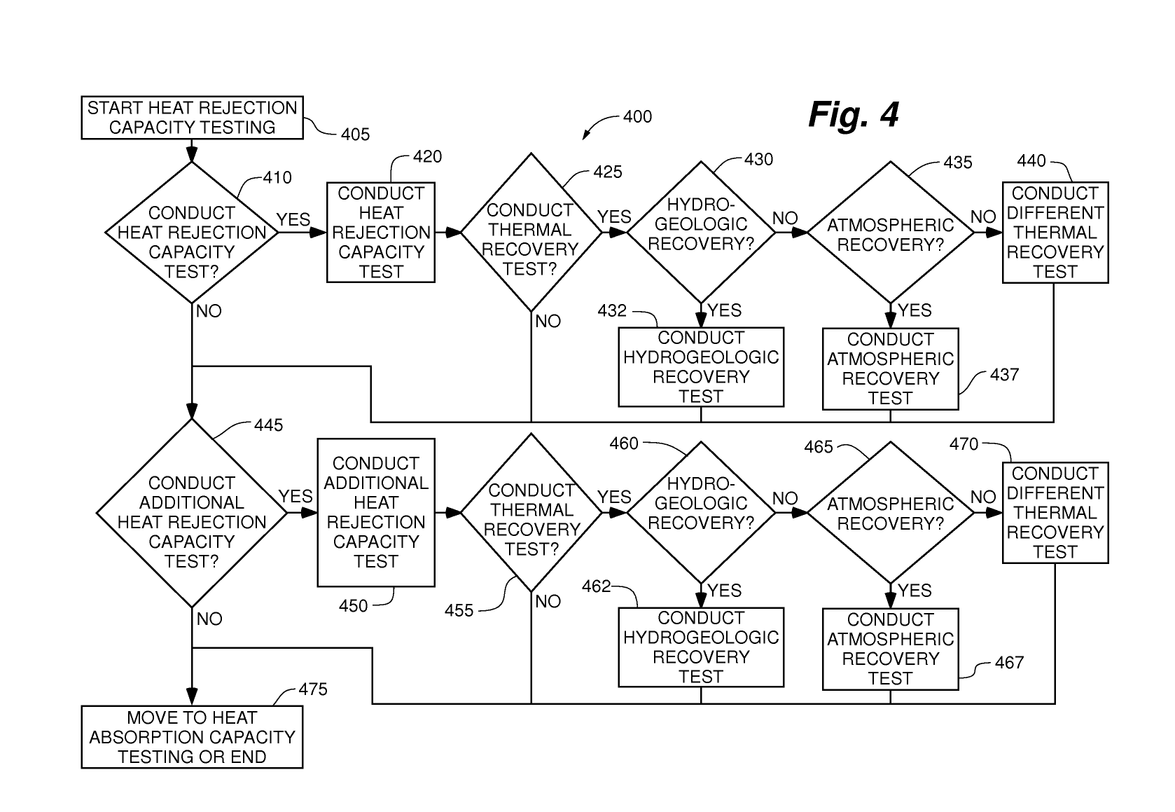

FIGS. 4-9 show illustrative tests that can be conducted by design modules such as those discussed herein. FIG. 4 shows an illustrative test 400 that can be conducted by a design module to assess the capacity of a particular ground heat exchanger to reject heat to a particular physical environment. The first step can be to start heat rejection capacity testing 405. The design module can determine whether to conduct a heat rejection capacity test (e.g., a heat rejection capacity test as discussed herein) 410. If it is determined by the design module to conduct a heat rejection capacity test, the design module can proceed to conduct the heat rejection capacity test 420. As discussed, when a ground heat exchanger rejects heat to a physical environment over time, the physical environment can approach heat saturation, making the ground heat exchanger less capable of rejecting heat to the physical environment.

With the physical environment warmed above its equilibrium temperature, the design module can determine whether to conduct a thermal recovery test 425. To conduct further testing on the characteristics of the ground heat exchanger and/or the physical environment, it is often important to first bring the physical environment back to or near its equilibrium temperature. In many cases, as long as the recharging or recovery is occurring anyway, the design module may measure the recharging or recovery to gain additional information about how the physical environment recharges or recovers. In some instances, the design module may determine that a thermal recovery test need not be conducted.

If it is determined by the design module to conduct a thermal recovery test, the design module may then determine which kind of thermal recovery test to conduct. The design module can determine whether a hydrogeologic recovery test should be conducted 430. If the design module determines that a hydrogeologic recovery test should be conducted, the design module can proceed to conduct the hydrogeologic recovery test 432. If the design module determines that a hydrogeologic recovery test should not be conducted, the design module can determine whether an atmospheric recovery test should be conducted 435. If the design module determines that an atmospheric recovery test should be conducted, the design module can proceed to conduct the atmospheric recovery test 437. If the design module determines that neither a hydrogeologic recovery test nor an atmospheric recovery test should be conducted, the design module may proceed to conduct a different thermal recovery test 440. In some instances, one kind of thermal recovery test can be conducted as the physical environment partially recovers or recharges, and another kind of thermal recovery test can be conducted as the physical environment completes its recovery or recharging. In some instances, measurements can be taken starting at the end of the heat rejection capacity test and ending when the physical environment reaches its equilibrium temperature. In some instances, measurements can be taken for a portion of the time between the end of the heat rejection capacity test and when the physical environment reaches its equilibrium temperature.

If the design module determines that a heat rejection capacity test need not be conducted (e.g., because one has already been conducted), the design module may determine whether an additional heat rejection capacity test (e.g., an additional heat rejection capacity test as discussed herein) should be conducted 445. If it is determined by the design module to conduct an additional heat rejection capacity test, the design module can proceed to conduct the additional heat rejection capacity test 450. In many instances, an additional heat rejection capacity test can likewise raise the temperature of the physical environment significantly above its equilibrium temperature. Before conducting further tests, the temperature of the physical environment is typically lowered to or near its equilibrium temperature, meaning that the design module may again determine whether to a thermal recovery test 455. The design module can determine whether a hydrogeologic recovery test should be conducted 460 and, if yes, conduct the hydrogeologic recovery test 462. The design module can determine whether an atmospheric recovery test should be conducted 465 and, if yes, conduct the atmospheric recovery test 467. If neither a hydrogeologic recovery test nor an atmospheric recovery test is warranted, the design module can conduct a different thermal recovery test 470.

After conducting (or not conducting) a heat rejection capacity test and conducting (or not conducting) an additional heat rejection capacity test, the design module can conduct a variety of other tests. For example, the design module can conduct additional heat rejection testing. In many embodiments, the design module can move to heat absorption capacity testing or conduct no further tests 475.

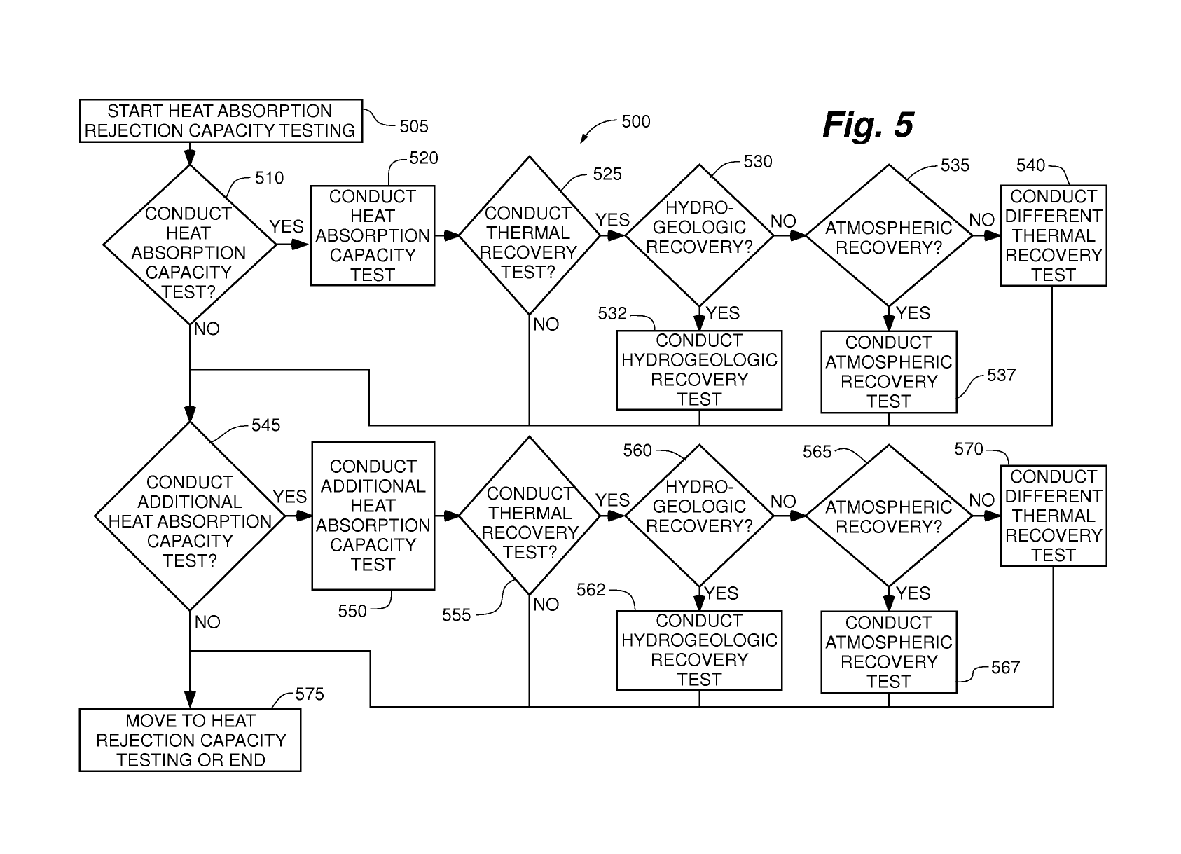

FIG. 5 shows an illustrative test 500 that can be conducted by a design module to assess the capacity of a particular ground heat exchanger to absorb heat from a particular physical environment. The first step can be to start heat absorption capacity testing 505. The design module can determine whether to conduct a heat absorption capacity test (e.g., a heat absorption capacity test as discussed herein) 510. If it is determined by the design module to conduct a heat absorption capacity test, the design module can proceed to conduct the heat absorption capacity test 520. As discussed, when a ground heat exchanger absorbs heat from a physical environment over time, the physical environment can approach heat depletion, making the ground heat exchanger less capable of absorbing heat from the physical environment.

With the physical environment cooled below its equilibrium temperature, the design module can determine whether to conduct a thermal recovery test 525. As noted, to conduct further testing on the characteristics of the ground heat exchanger and/or the physical environment, it is often important to first bring the physical environment back to or near its equilibrium temperature. In many cases, as long as the recharging or recovery is occurring anyway, the design module may measure the recharging or recovery to gain additional information about how the physical environment recharges or recovers. In some instances, the design module may determine that a thermal recovery test need not be conducted.

If it is determined by the design module to conduct a thermal recovery test, the design module may then determine which kind of thermal recovery test to conduct. The design module can determine whether a hydrogeologic recovery test should be conducted 530. If the design module determines that a hydrogeologic recovery test should be conducted, the design module can proceed to conduct the hydrogeologic recovery test 532. If the design module determines that a hydrogeologic recovery test should not be conducted, the design module can determine whether an atmospheric recovery test should be conducted 535. If the design module determines that an atmospheric recovery test should be conducted, the design module can proceed to conduct the atmospheric recovery test 537. If the design module determines that neither a hydrogeologic recovery test nor an atmospheric recovery test should be conducted, the design module may proceed to conduct a different thermal recovery test 540. Characteristics of thermal recovery tests discussed elsewhere herein can be incorporated into the thermal recovery tests shown in FIG. 5.

If the design module determines that a heat absorption capacity test need not be conducted (e.g., because one has already been conducted), the design module may determine whether an additional heat absorption capacity test (e.g., an additional heat absorption capacity test as discussed herein) should be conducted 545. If it is determined by the design module to conduct an additional heat absorption capacity test, the design module can proceed to conduct the additional heat absorption capacity test 550. In many instances, an additional heat absorption capacity test can likewise lower the temperature of the physical environment significantly below its equilibrium temperature. Before conducting further tests, the temperature of the physical environment is typically raised to or near its equilibrium temperature, meaning that the design module may again determine whether to a thermal recovery test 555. The design module can determine whether a hydrogeologic recovery test should be conducted 560 and, if yes, conduct the hydrogeologic recovery test 562. The design module can determine whether an atmospheric recovery test should be conducted 565 and, if yes, conduct the atmospheric recovery test 567. If neither a hydrogeologic recovery test nor an atmospheric recovery test is warranted, the design module can conduct a different thermal recovery test 570.

After conducting (or not conducting) a heat absorption capacity test and conducting (or not conducting) an additional heat absorption capacity test, the design module can conduct a variety of other tests. For example, the design module can conduct additional heat absorption testing. In many embodiments, the design module can move to heat rejection capacity testing or conduct no further tests 575.

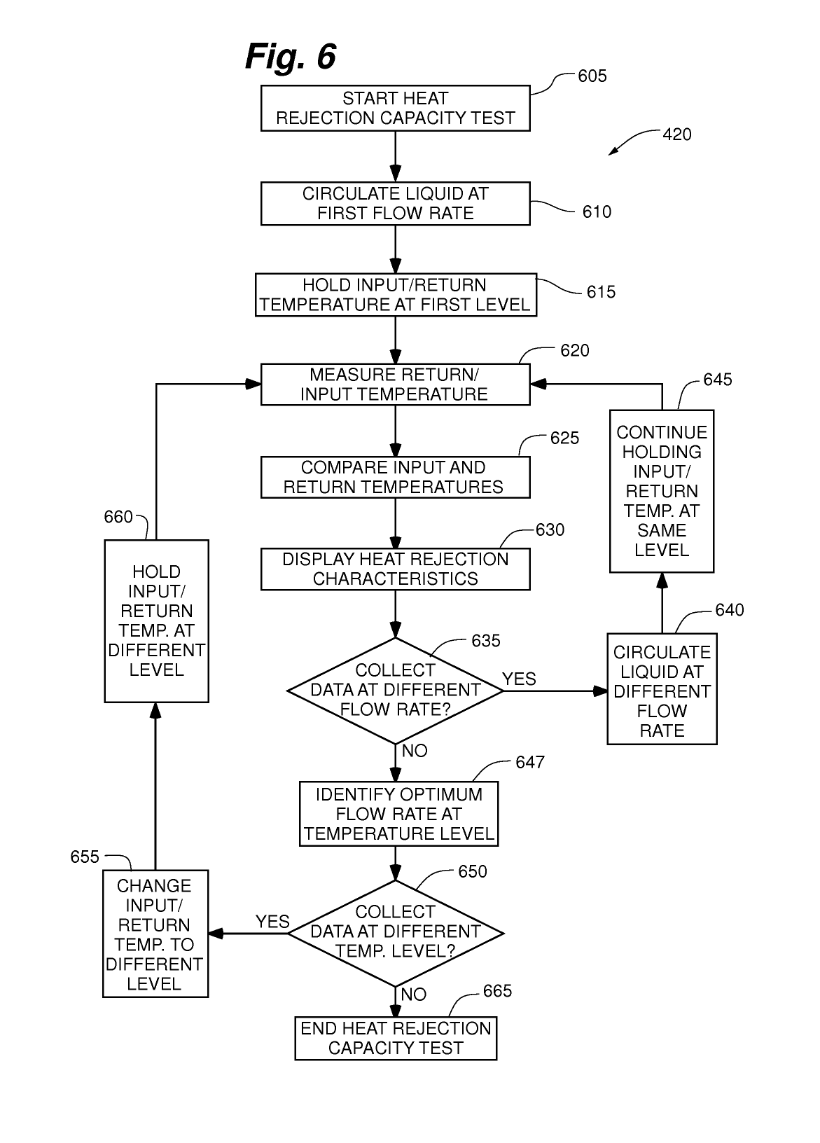

FIG. 6 shows an illustrative heat rejection capacity test 420. The first step can be to start the heat rejection capacity test 605. The design module can circulate liquid at a first flow rate 610. In some embodiments, the first flow rate can be a flow rate at a lower end of the design module's flow rate range, and subsequent flow rates can be increased. In some embodiments, the first flow rate can be a flow rate at a higher end of the design module's flow rate range, and subsequent flow rates can be decreased.

The design module can hold the input temperature or return temperature (T1 or T2 of FIGS. 1A-1B, respectively) at a first level 615. As noted, some design module embodiments hold the input temperature constant and measure the return temperature, and some design modules hold the return temperature constant and measure the input temperature. In many embodiments, the first temperature level is only slightly above the ground equilibrium temperature. For example, if the ground equilibrium temperature is 55° F., the first temperature level may be 60° F. or 65° F., even though the building's heating/cooling equipment can accommodate significantly higher temperatures.

The design module can measure whichever of the input temperature or return temperature is not being held constant 620 and can compare the input and return temperatures 625 to determine heat rejection characteristics of the ground heat exchanger and the physical environment. In many embodiments, some or all of the heat rejection characteristics can be displayed to a user 630.

In many embodiments, a design module can collect heat rejection capacity information at a variety of different flow rates with the input and return temperatures at the same level. The design module can determine whether to collect data at a different flow rate 635. If the design module determines that data should be collected at a different flow rate, the design module can circulate liquid through the ground heat exchanger at a different flow rate 640. In many instances, a pump in the load loop can increase the flow rate by a predetermined amount (e.g., 1 gpm). The design module can continue holding the input temperature or the return temperature (depending on the embodiment) at the same level 645. The design module can then measure whichever of the input temperature or return temperature is not being held constant 620, compare input and return temperatures 625, and display heat rejection characteristics 630. This process can continue until the design module determines that no data at flow rates other than those that have already been tested need be collected. In some preferred embodiments, heat rejection capacity information can be collected at several liquid flow rates, and it can be determined which flow rate facilitates the greatest heat rejection capacity at that temperature level 647. This optimum or high-heat-rejection-capacity flow rate can be used in further testing and/or can be used in eventually operating the full geothermal heat exchange system. In operation, different flow rates may provide optimum heat exchange capacity, depending on the ground heat exchanger, the physical environment, the heat exchange load, etc. Testing at different flow rates in the design process can help find those optimum flow rates.

When the design module has determined that no data at flow rates other than those that have already been tested need be collected, the design module can determine whether to collect heat rejection capacity data at a different temperature level 650. If it is determined that such additional data should be collected, the design module can change the input temperature or the return temperature (depending on the embodiment) to a different temperature level 655. In many embodiments, the design module collects heat rejection capacity information at multiple levels between the ground equilibrium temperature and the maximum temperature that can be handled by the heating/cooling equipment. In some embodiments, the first temperature level can be just above the ground equilibrium temperature (e.g., 60° F. or 65° F.), and the design module can increase the temperature level by a predetermined interval (e.g., 5° F.) until the temperature reaches the maximum temperature that can be handled by the heating/cooling equipment (e.g., 90° F.). In some such embodiments, the design module can determine an optimum or high-heat-rejection-capacity flow rate at each temperature level 647. After the design module has changed the input temperature or return temperature to the different level 655, the design module can hold the input temperature or return temperature at that level 660 for further measurement 620, comparison 625, and display 630. When the design module determines that no data at temperature levels other than those that have already been tested need be collected, the heat rejection capacity test can be at an end 665.

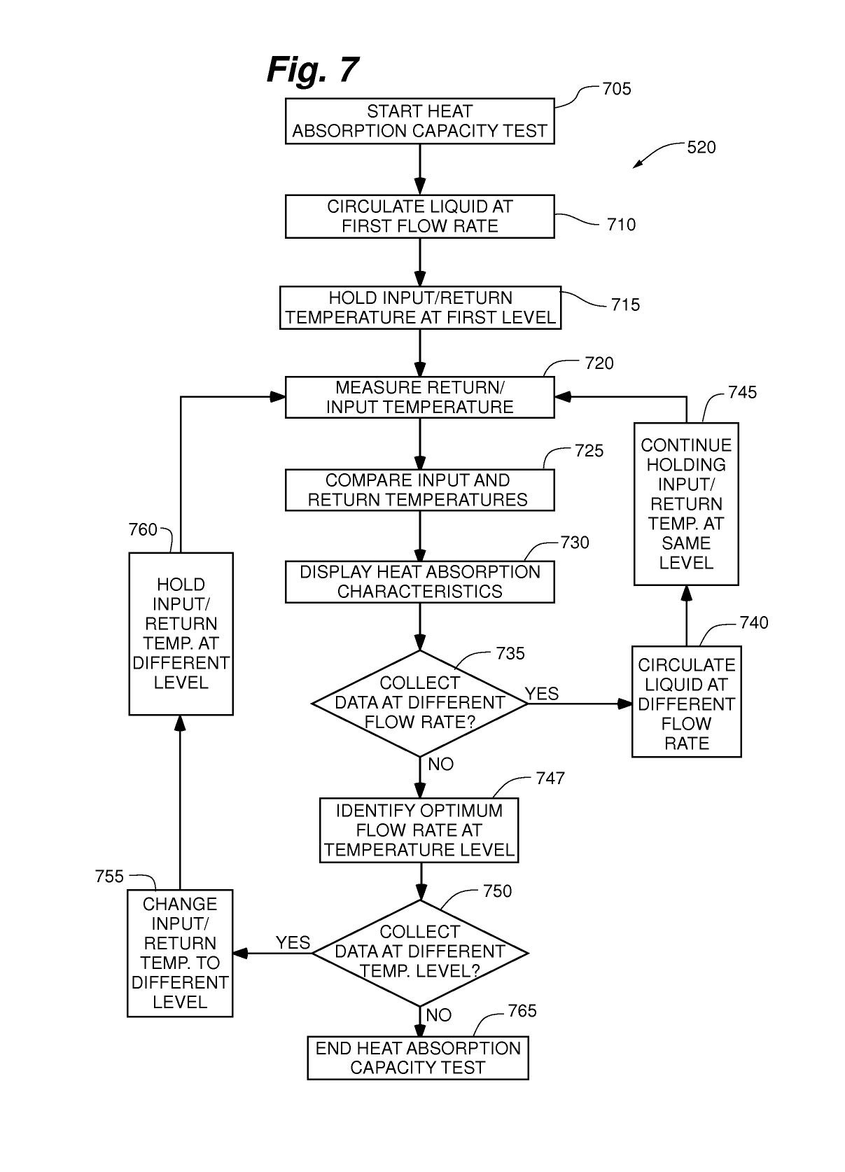

FIG. 7 shows an illustrative heat absorption capacity test 520. The first step can be to start the heat absorption capacity test 705. The design module can circulate liquid at a first flow rate 710. The flow rates tested in the heat absorption capacity test can have the same or different attributes as the flow rates tested in the heat rejection capacity test. The design module can hold the input temperature or return temperature (depending on the embodiment) at a first level 715. In many embodiments, the first temperature level is only slightly below the ground equilibrium temperature. For example, if the ground equilibrium temperature is 55° F., the first temperature level may be 50° F. or 45° F., even though the building's heating/cooling equipment can accommodate significantly lower temperatures. The design module can measure whichever of the input temperature or return temperature is not being held constant 720 and can compare the input and return temperatures 725 to determine heat absorption characteristics of the ground heat exchanger and the physical environment. In many embodiments, some or all of the heat absorption characteristics can be displayed to a user 730.

In many embodiments, a design module can collect heat absorption capacity information at a variety of different flow rates with the input and return temperatures at the same level. The design module can determine whether to collect data at a different flow rate 735. If the design module determines that data should be collected at a different flow rate, the design module can circulate liquid through the ground heat exchanger at a different flow rate 740. As in many heat rejection capacity tests, in many instances, a pump in the load loop can increase the flow rate by a predetermined amount (e.g., 1 gpm). The design module can continue holding the input temperature or the return temperature (depending on the embodiment) at the same level 745. The design module can then measure whichever of the input temperature or return temperature is not being held constant 720, compare input and return temperatures 725, and display heat absorption characteristics 730. This process can continue until the design module determines that no data at flow rates other than those that have already been tested need be collected. In some preferred embodiments, heat absorption capacity information can be collected at several liquid flow rates, and it can be determined which flow rate facilitates the greatest heat absorption at that temperature level 747. This optimum or high-heat-absorption-capacity flow rate can be used in further testing and/or can be used in eventually operating the full geothermal heat exchange system.

When the design module has determined that no data at flow rates other than those that have already been tested need be collected, the design module can determine whether to collect heat absorption capacity data at a different temperature level 750. If it is determined that such additional data should be collected, the design module can change the input temperature or the return temperature (depending on the embodiment) to a different temperature level 755. In many embodiments, the design module collects heat absorption capacity information at multiple levels between the ground equilibrium temperature and the minimum temperature that can be handled by the heating/cooling equipment. In some embodiments, the first temperature level can be just below the ground equilibrium temperature (e.g., 45° F. or 50° F.), and the design module can decrease the temperature level by a predetermined interval (e.g., 5° F.) until the temperature reaches the minimum temperature that can be handled by the heating/cooling equipment (e.g., 30° F.). In some such embodiments, the design module can determine an optimum or high-heat-absorption-capacity flow rate at each temperature level 747. After the design module has changed the input temperature or return temperature to the different level 755, the design module can hold the input temperature or return temperature at that level 760 for further measurement 720, comparison 725, and display 730. When the design module determines that no data at temperature levels other than those that have already been tested need be collected, the heat absorption capacity test can be at an end 765.

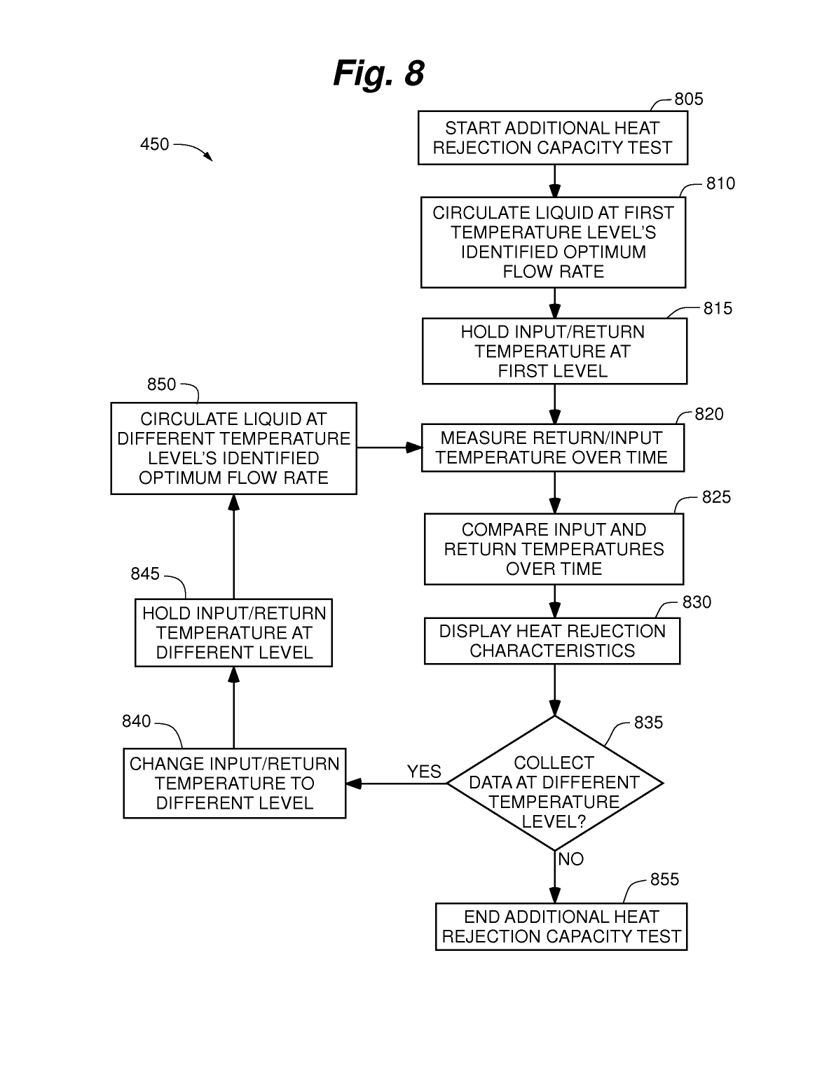

FIG. 8 shows an illustrative additional heat rejection capacity test 450. The first step can be for the design module to start the additional heat rejection capacity test 805. The design module can circulate liquid through the ground heat exchanger at the first temperature level's identified optimum or high-heat-rejection-capacity flow rate 810, which can be determined in a heat rejection capacity test as discussed elsewhere herein. The design module can hold the input temperature or the return temperature (depending on the embodiment) at a first temperature level 815. In many embodiments, the temperature levels used in the additional heat rejection capacity test are the same as are used in the heat rejection capacity test. In some embodiments, the temperature levels used in the additional heat rejection capacity test are different from those that are used in the heat rejection capacity test. The design module can measure the input temperature or the return temperature (depending on the embodiment) over time 820, compare the input and return temperatures over time 825, and display heat rejection characteristics 830 determined from the comparison. In many cases, the heat rejection characteristics determined from the comparison can include the rate of change of the difference between the input and return temperatures as the physical environment approaches heat saturation.

As noted, in many embodiments, the additional heat rejection capacity test can be conducted at several temperature levels. The design module can determine whether to collect data at a different temperature level 835. If it is determined that data should be collected at a different temperature level, the design module can change the input temperature or return temperature (depending on the embodiment) to the different temperature level 840 and hold it there 845. The design module can then circulate the liquid through the ground heat exchanger at that different temperature level's identified optimum or high-heat-rejection-capacity flow rate 850 for further measurement 820, comparison 825, and display 830. When the design module determines that no data at temperature levels other than those that have already been tested need be collected, the additional heat rejection capacity test can be at an end 855.

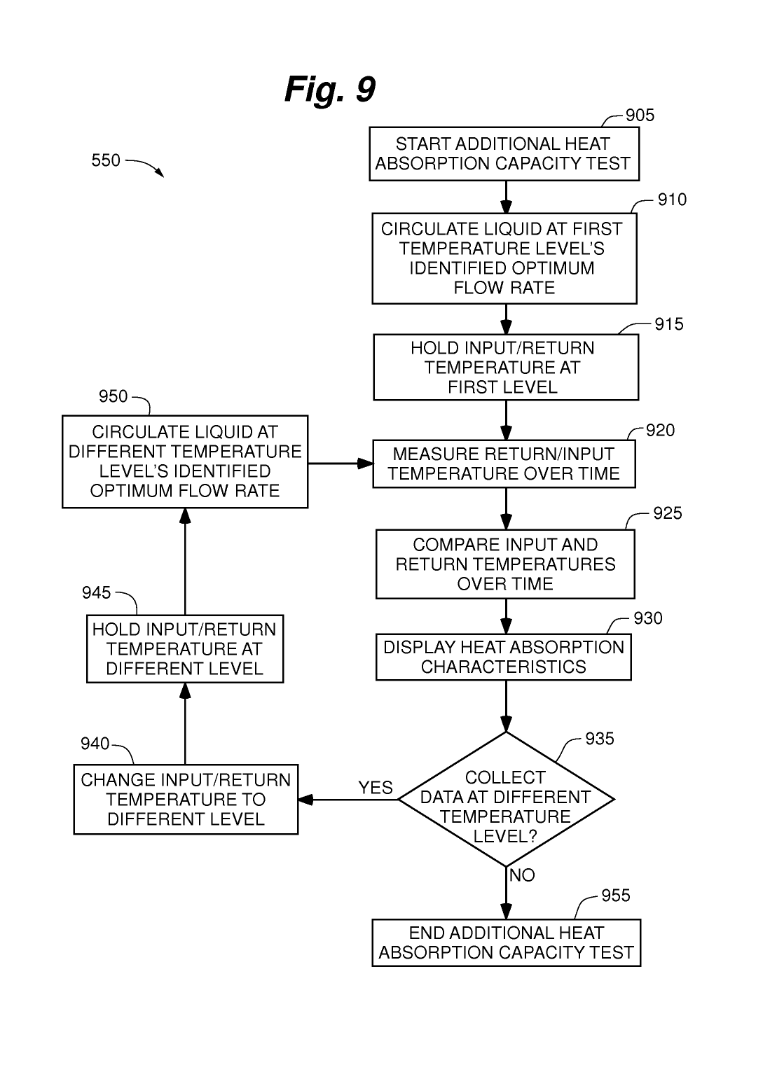

FIG. 9 shows an illustrative additional heat absorption capacity test 550. The first step can be for the design module to start the additional heat absorption capacity test 905. The design module can circulate liquid through the ground heat exchanger at the first temperature level's identified optimum or high-heat-absorption-capacity flow rate 910, which can be determined in a heat absorption capacity test as discussed elsewhere herein. The design module can hold the input temperature or the return temperature (depending on the embodiment) at a first temperature level 915. In many embodiments, the temperature levels used in the additional heat absorption capacity test are the same as are used in the heat absorption capacity test. In some embodiments, the temperature levels used in the additional heat absorption capacity test are different from those that are used in the heat absorption capacity test. The design module can measure the input temperature or the return temperature (depending on the embodiment) over time 920, compare the input and return temperatures over time 925, and display heat absorption characteristics 930 determined from the comparison. In many cases, the heat absorption characteristics determined from the comparison can include the rate of change of the difference between the input and return temperatures as the physical environment approaches heat depletion.

As noted, in many embodiments, the additional heat absorption capacity test can be conducted at several temperature levels. The design module can determine whether to collect data at a different temperature level 935. If it is determined that data should be collected at a different temperature level, the design module can change the input temperature or return temperature (depending on the embodiment) to the different temperature level 940 and hold it there 945. The design module can then circulate the liquid through the ground heat exchanger at that different temperature level's identified optimum or high-heat-absorption-capacity flow rate 950 for further measurement 920, comparison 925, and display 930. When the design module determines that no data at temperature levels other than those that have already been tested need be collected, the additional heat absorption capacity test can be at an end 955.

In the foregoing detailed description, the invention has been described with reference to specific embodiments. However, it may be appreciated that various modifications and changes can be made without departing from the scope of the invention. Thus, some of the features of preferred embodiments described herein are not necessarily included in preferred embodiments of the invention which are intended for alternative uses.

1. A method of collecting information to be used in designing a geothermal heat exchange system, the method comprising:
(a) using a design module to circulate liquid through a ground heat exchanger in a physical environment, the liquid having an input temperature entering the ground heat exchanger and a return temperature returning from the ground heat exchanger;
(b) conducting a heat rejection capacity test with the design module to determine heat rejection characteristics of the ground heat exchanger in the physical environment;
(c) conducting a heat absorption capacity test with the design module to determine heat absorption characteristics of the ground heat exchanger in the physical environment; and
(d) conducting a thermal recovery test with the design module between conducting the heat rejection capacity test and conducting the heat absorption capacity test to determine thermal recovery characteristics of the physical environment.

2. The method of claim 1, wherein conducting the heat rejection capacity test occurs before conducting the thermal recovery test.

3. The method of claim 1, wherein conducting the heat absorption capacity test occurs before conducting the thermal recovery test.

4. The method of claim 1, wherein the heat rejection capacity test includes:
(i) circulating the liquid through the ground heat exchanger at a first flow rate,
(ii) holding the liquid's input temperature or return temperature at a first temperature level that is above a ground equilibrium temperature,
(iii) measuring whichever of the liquid's input temperature or return temperature is not being held at the first temperature level, and
(iv) comparing the liquid's input temperature and return temperature over time to determine heat rejection characteristics of the ground heat exchanger in the physical environment.

5. The method of claim 4, wherein the heat rejection capacity test further includes:
(v) circulating the liquid through the ground heat exchanger at a second flow rate that differs from the first flow rate, and
(vi) repeating steps (ii), (iii), and (iv).

6. The method of claim 5, wherein one of the determined heat rejection characteristics is whether the first flow rate or the second flow rate provides greater heat rejection capacity with the liquid's input temperature or return temperature at the first temperature level.

7. The method of claim 4, wherein the heat rejection capacity test further includes:
(v) changing the liquid's input temperature or return temperature to a second temperature level that is above the ground equilibrium temperature and differs from the first temperature level,
(vi) holding the liquid's input temperature or return temperature at the second temperature level,
(vii) measuring whichever of the liquid's input temperature or return temperature is not being held at the second temperature level, and
(viii) repeating step (iv).

8. The method of claim 7, wherein the heat rejection capacity test further includes:
(ix) circulating the liquid through the ground heat exchanger at a second flow rate that differs from the first flow rate after step (iv) but before step (v), and
(x) repeating steps (ii), (iii), and (iv) before proceeding to step (v).

9. The method of claim 8, wherein the heat rejection capacity test further includes:
(xi) circulating the liquid through the ground heat exchanger at the second flow rate after step (viii), and
(xii) repeating steps (vi), (vii), and (viii).

10. The method of claim 7, wherein the heat rejection capacity test further includes:
(ix) changing the liquid's input temperature or return temperature to a third temperature level that is above the ground equilibrium temperature and differs from the first temperature level and the second temperature level,
(x) holding the liquid's input temperature or return temperature at the third temperature level,
(xi) measuring whichever of the liquid's input temperature or return temperature is not being held at the third temperature level, and
(xii) repeating step (iv).

11. The method of claim 4, wherein the heat rejection capacity test includes:
(ii) holding the liquid's input temperature at the first temperature level, and
(iii) measuring the liquid's return temperature.

12. The method of claim 1, wherein the heat rejection capacity test includes comparing the liquid's input temperature and return temperature at two or more liquid flow rates and an input temperature level above a ground equilibrium temperature to determine which of the two or more liquid flow rates provides greatest heat rejection capacity at the input temperature level.

13. The method of claim 12, further comprising:
(e) conducting an additional heat rejection capacity test with the design module to determine additional heat rejection characteristics of the ground heat exchanger in the physical environment, the additional heat rejection capacity test including comparing the liquid's input temperature and return temperature at the input temperature level and at whichever liquid flow rate is determined to provide greatest heat rejection capacity at the input temperature level.

14. The method of claim 1, wherein the heat rejection capacity test includes comparing the liquid's input temperature and return temperature at three or more liquid flow rates and three or more input temperature levels, each input temperature level being above a ground equilibrium temperature, to determine heat rejection characteristics of the ground heat exchanger in the physical environment.

15. The method of claim 1, wherein the heat absorption capacity test includes:
(i) circulating the liquid through the ground heat exchanger at a first flow rate,
(ii) holding the liquid's input temperature or return temperature at a first temperature level that is below a ground equilibrium temperature,
(iii) measuring whichever of the liquid's input temperature or return temperature is not being held at the first temperature level, and
(iv) comparing the liquid's input temperature and return temperature over time to determine heat absorption characteristics of the ground heat exchanger in the physical environment.

16. The method of claim 15, wherein the heat absorption capacity test further includes:
(v) circulating the liquid through the ground heat exchanger at a second flow rate that differs from the first flow rate, and
(vi) repeating steps (ii), (iii), and (iv).

17. The method of claim 16, wherein one of the determined heat absorption characteristics is whether the first flow rate or the second flow rate provides greater heat absorption capacity with the liquid's input temperature or return temperature at the first temperature level.

18. The method of claim 15, wherein the heat absorption capacity test further includes:
(v) changing the liquid's input temperature or return temperature to a second temperature level that is below the ground equilibrium temperature and differs from the first temperature level,
(vi) holding the liquid's input temperature or return temperature at the second temperature level,
(vii) measuring whichever of the liquid's input temperature or return temperature is not being held at the second temperature level, and
(viii) repeating step (iv).

19. The method of claim 18, wherein the heat absorption capacity test further includes:
(ix) circulating the liquid through the ground heat exchanger at a second flow rate that differs from the first flow rate after step (iv) but before step (v), and
(x) repeating steps (ii), (iii), and (iv) before proceeding to step (v).

20. The method of claim 19, wherein the heat absorption capacity test further includes:
(xi) circulating the liquid through the ground heat exchanger at the second flow rate after step (viii), and
(xii) repeating steps (vi), (vii), and (viii).

21. The method of claim 18, wherein the heat absorption capacity test further includes:
(ix) changing the liquid's input temperature or return temperature to a third temperature level that is below the ground equilibrium temperature and differs from the first temperature level and the second temperature level,
(x) holding the liquid's input temperature or return temperature at the third temperature level,
(xi) measuring whichever of the liquid's input temperature or return temperature is not being held at the third temperature level, and
(xii) repeating step (iv).

22. The method of claim 15, wherein the heat absorption capacity test includes:
(ii) holding the liquid's input temperature at the first temperature level, and
(iii) measuring the liquid's return temperature.

23. The method of claim 1, wherein the heat absorption capacity test includes comparing the liquid's input temperature and return temperature at two or more liquid flow rates and an input temperature level below a ground equilibrium temperature to determine which of the two or more liquid flow rates provides greater heat absorption capacity at the input temperature level.

24. The method of claim 23, further comprising
(e) conducting an additional heat absorption capacity test with the design module to determine additional heat absorption characteristics of the ground heat exchanger in the physical environment, the additional heat absorption capacity test including comparing the liquid's input temperature and return temperature at the input temperature level and at whichever liquid flow rate is determined to provide greatest heat absorption capacity at the input temperature level.

25. The method of claim 1, wherein the heat absorption capacity test includes comparing the liquid's input temperature and return temperature at three or more liquid flow rates and three or more input temperature levels, each input temperature level being below a ground equilibrium temperature, to determine heat absorption characteristics of the ground heat exchanger in the physical environment.

26. The method of claim 1, wherein the heat rejection capacity test involves the design module adding heat to the liquid, and the heat absorption capacity test involves the design module removing heat from the liquid.

27. The method of claim 26, wherein the thermal recovery test involves the design module neither adding heat to the liquid nor removing heat from the liquid, the thermal recovery test including measuring a length of time for the input temperature and the return temperature to approximate a ground equilibrium temperature.

28. The method of claim 26, wherein the thermal recovery test involves the design module removing heat from the liquid in a manner that simulates a supplemental heat exchanger, the thermal recovery test including measuring a length of time for the input temperature and the return temperature to approximate a ground equilibrium temperature.

29. The method of claim 1, wherein
the heat rejection capacity test includes comparing the liquid's input temperature and return temperature at a first set of liquid flow rates and a raised input temperature level above a ground equilibrium temperature to determine which of the first set of liquid flow rates provides greatest heat rejection capacity at the raised input temperature level,
the heat absorption capacity test includes comparing the liquid's input temperature and return temperature at a second set of liquid flow rates and a lowered input temperature level below the ground equilibrium temperature to determine which of the second set of liquid flow rates provides greatest heat absorption capacity at the lowered input temperature level, and
the method further comprises:
(e) conducting an additional heat rejection capacity test with the design module, the additional heat rejection capacity test including comparing the liquid's input temperature and return temperature at the raised input temperature level and at whichever of the first set of liquid flow rates is determined to provide greatest heat rejection capacity at the raised input temperature level; and
(f) conducting an additional heat absorption capacity test with the design module, the additional heat absorption capacity test including comparing the liquid's input temperature and return temperature at the lowered input temperature level and at whichever of the second set of liquid flow rates is determined to provide greatest heat absorption capacity at the lowered input temperature level.

30. The method of claim 29, further comprising:
(g) conducting a first additional thermal recovery test with the design module after conducting the heat rejection capacity test but before conducting the additional heat rejection capacity test; and
(h) conducting a second additional thermal recovery test with the design module after conducting the heat absorption capacity test but before conducting the additional heat absorption capacity test.

31. The method of claim 30, wherein conducting the additional heat rejection capacity test occurs before conducting the thermal recovery test.

32. The method of claim 30, wherein conducting the additional heat absorption capacity test occurs before conducting the thermal recovery test.

33. The method of claim 30, wherein
the first additional thermal recovery test involves the design module neither adding heat to the liquid nor removing heat from the liquid, the first additional thermal recovery test including measuring a first length of time for the input temperature and the return temperature to approximate the ground equilibrium temperature,
the thermal recovery test involves the design module removing heat from the liquid in a manner that simulates a supplemental heat exchanger, the thermal recovery test including measuring a second length of time for the input temperature and the return temperature to approximate the ground equilibrium temperature, and
the second additional thermal recovery test involves the design module neither adding heat to the liquid nor removing heat from the liquid, the second additional thermal recovery test including measuring a third length of time for the input temperature and the return temperature to approximate the ground equilibrium temperature.

34. The method of claim 1, wherein one of the determined heat rejection characteristics is how many units of heat energy per unit time the ground heat exchanger can reject to the physical environment.

35. The method of claim 1, wherein one of the determined heat absorption characteristics is how many units of heat energy per unit time the ground heat exchanger can absorb from the physical environment.

36. The method of claim 1, wherein the ground heat exchanger is a buried closed loop heat exchanger.

37. The method of claim 1, further comprising:
(e) displaying heat rejection characteristics and heat absorption characteristics of the ground heat exchanger in the physical environment; and
(f) displaying thermal recovery characteristics of the physical environment.

38. The method of claim 37, wherein both the displaying of heat rejection characteristics and heat absorption characteristics of the ground heat exchanger in the physical environment and the displaying of thermal recovery characteristics of the physical environment are in real time.

39. A system for designing a geothermal heat exchange system, the system comprising:
(a) a ground heat exchanger in a physical environment; and
(b) a design module connected to and configured to circulate liquid through the ground heat exchanger, the liquid having an input temperature entering the ground heat exchanger and a return temperature returning from the ground heat exchanger, the design module being configured to:
(i) conduct a heat rejection capacity test to determine heat rejection characteristics of the ground heat exchanger in the physical environment,
(ii) conduct a heat absorption capacity test to determine heat absorption characteristics of the ground heat exchanger in the physical environment, and
(iii) conduct a thermal recovery test between conducting the heat rejection capacity test and conducting the heat absorption capacity test to determine thermal recovery characteristics of the physical environment.

40. The system of claim 9, wherein the design module is in a mobile unit.

41. The system of claim 39, wherein the design module is configured to conduct the heat rejection capacity test before the thermal recovery test.

42. The system of claim 39, wherein the design module is configured to conduct the heat absorption capacity test before the thermal recovery test.

43. The system of claim 39, wherein the design module is configured to do the following when conducting the heat rejection capacity test:
(A) circulate the liquid through the ground heat exchanger at a first flow rate,
(B) hold the liquid's input temperature or return temperature at a first temperature level that is above a ground equilibrium temperature,
(C) measure whichever of the liquid's input temperature or return temperature is not being held at the first temperature level, and
(D) compare the liquid's input temperature and return temperature over time to determine heat rejection characteristics of the ground heat exchanger in the physical environment.

44. The system of claim 43, wherein the design module is further configured to do the following when conducting the heat rejection capacity test:
(E) circulate the liquid through the ground heat exchanger at a second flow rate that differs from the first flow rate, and
(F) repeat steps (B), (C), and (D).

45. The system of claim 44, wherein one of the determined heat rejection characteristics is whether the first flow rate or the second flow rate provides greater heat rejection capacity with the liquid's input temperature or return temperature at the first temperature level.

46. The system of claim 43, wherein the design module is further configured to do the following when conducting the heat rejection capacity test:
(E) change the liquid's input temperature or return temperature to a second temperature level that is above the ground equilibrium temperature and differs from the first temperature level,
(F) hold the liquid's input temperature or return temperature at the second temperature level,
(G) measure whichever of the liquid's input temperature or return temperature is not being held at the second temperature level, and
(H) repeat step (D).

47. The system of claim 46, wherein the design module is further configured to do the following when conducting the heat rejection capacity test:
(I) circulate the liquid through the ground heat exchanger at a second flow rate that differs from the first flow rate after step (D) but before step (E), and
(J) repeat steps (B), (C), and (D) before proceeding to step (E).

48. The system of claim 47, wherein the design module is further configured to do the following when conducting the heat rejection capacity test:
(K) circulate the liquid through the ground heat exchanger at the second flow rate after step (H), and
(L) repeat steps (F), (G), and (H).

49. The system of claim 46, wherein the design module is further configured to do the following when conducting the heat rejection capacity test:
(I) change the liquid's input temperature or return temperature to a third temperature level that is above the ground equilibrium temperature and differs from the first temperature level and the second temperature level,
(J) hold the liquid's input temperature or return temperature at the third temperature level,
(K) measure whichever of the liquid's input temperature or return temperature is not being held at the third temperature level, and
(L) repeat step (D).

50. The system of claim 43, wherein the design module is further configured to do the following when conducting the heat rejection capacity test:
(B) hold the liquid's input temperature at the first temperature level, and
(C) measure the liquid's return temperature.

51. The system of claim 39, wherein, when conducting the heat rejection capacity test, the design module is further configured to compare the liquid's input temperature and return temperature at two or more liquid flow rates and an input temperature level above a ground equilibrium temperature to determine which of the two or more liquid flow rates provides greatest heat rejection capacity at the input temperature level.

52. The system of claim 51, wherein the design module is further configured to:
(iv) conduct an additional heat rejection capacity test to determine additional heat rejection characteristics of the ground heat exchanger in the physical environment, wherein, when conducting the additional heat rejection capacity test, the design module is further configured to compare the liquid's input temperature and return temperature at the input temperature level and at whichever liquid flow rate is determined to provide greatest heat rejection capacity at the input temperature level.

53. The system of claim 39, wherein, when conducting the heat rejection capacity test, the design module is further configured to compare the liquid's input temperature and return temperature at three or more liquid flow rates and three or more input temperature levels, each input temperature level being above a ground equilibrium temperature, to determine heat rejection characteristics of the ground heat exchanger in the physical environment.

54. The system of claim 39, wherein the design module is further configured to do the following when conducting the heat absorption capacity test:
(A) circulate the liquid through the ground heat exchanger at a first flow rate,
(B) hold the liquid's input temperature or return temperature at a first temperature level that is below a ground equilibrium temperature,
(C) measure whichever of the liquid's input temperature or return temperature is not being held at the first temperature level, and
(D) compare the liquid's input temperature and return temperature over time to determine heat absorption characteristics of the ground heat exchanger in the physical environment.

55. The system of claim 54, wherein the design module is further configured to do the following when conducting the heat absorption capacity test:
(E) circulate the liquid through the ground heat exchanger at a second flow rate that differs from the first flow rate, and
(F) repeat steps (B), (C), and (D).

56. The system of claim 55, wherein one of the determined heat absorption characteristics is whether the first flow rate or the second flow rate provides greater heat absorption capacity with the liquid's input temperature or return temperature at the first temperature level.

57. The system of claim 54, wherein the design module is further configured to do the following when conducting the heat absorption capacity test:
(E) change the liquid's input temperature or return temperature to a second temperature level that is below the ground equilibrium temperature and differs from the first temperature level,
(F) hold the liquid's input temperature or return temperature at the second temperature level,
(G) measure whichever of the liquid's input temperature or return temperature is not being held at the second temperature level, and
(H) repeat step (D).

58. The system of claim 57, wherein the design module is further configured to do the following when conducting the heat absorption capacity test:
(I) circulate the liquid through the ground heat exchanger at a second flow rate that differs from the first flow rate after step (D) but before step (E), and
(J) repeat steps (B), (C), and (D) before proceeding to step (E).

59. The system of claim 58, wherein the design module is further configured to do the following when conducting the heat absorption capacity test:
(K) circulate the liquid through the ground heat exchanger at the second flow rate after step (H), and
(L) repeat steps (F), (G), and (H).

60. The system of claim 57, wherein the design module is further configured to do the following when conducting the heat absorption capacity test:
(I) change the liquid's input temperature or return temperature to a third temperature level that is below the ground equilibrium temperature and differs from the first temperature level and the second temperature level,
(J) hold the liquid's input temperature or return temperature at the third temperature level,
(K) measure whichever of the liquid's input temperature or return temperature is not being held at the third temperature level, and
(L) repeat step (D).

61. The system of claim 54, wherein the design module is further configured to do the following when conducting the heat absorption capacity test:
(B) hold the liquid's input temperature at the first temperature level, and
(C) measure the liquid's return temperature.

62. The system of claim 39, wherein, when conducting the heat absorption capacity test, the design module is further configured to compare the liquid's input temperature and return temperature at two or more liquid flow rates and an input temperature level below a ground equilibrium temperature to determine which of the two or more liquid flow rates provides greater heat absorption capacity at the input temperature level.

63. The system of claim 62, wherein the design module is further configured to:
(iv) conduct an additional heat absorption capacity test to determine additional heat absorption characteristics of the ground heat exchanger in the physical environment, wherein, when conducting the additional heat absorption capacity test, the design module is further configured to compare the liquid's input temperature and return temperature at the input temperature level and at whichever liquid flow rate is determined to provide greatest heat absorption capacity at the input temperature level.

64. The system of claim 39, wherein, when conducting the heat absorption capacity test, the design module is further configured to compare the liquid's input temperature and return temperature at three or more liquid flow rates and three or more input temperature levels, each input temperature level being below a ground equilibrium temperature, to determine heat absorption characteristics of the ground heat exchanger in the physical environment.

65. The system of claim 39, wherein, when conducting the heat rejection capacity test, the design module adds heat to the liquid, and when conducting the heat absorption capacity test, the design module removes heat from the liquid.

66. The system of claim 65, wherein, when conducting the thermal recovery test, the design module neither adds heat to the liquid nor removes heat from the liquid, and the design module measures a length of time for the input temperature and the return temperature to approximate a ground equilibrium temperature.

67. The system of claim 65, wherein, when conducting the thermal recovery test, the design module removes heat from the liquid in a manner that simulates a supplemental heat exchanger, and the design module measures a length of time for the input temperature and the return temperature to approximate a ground equilibrium temperature.

68. The system of claim 39, wherein
when conducting the heat rejection capacity test, the design module compares the liquid's input temperature and return temperature at a first set of liquid flow rates and a raised input temperature level above a ground equilibrium temperature to determine which of the first set of liquid flow rates provides greatest heat rejection capacity at the raised input temperature level,
when conducting the heat absorption capacity test, the design module compares the liquid's input temperature and return temperature at a second set of liquid flow rates and a lowered input temperature level below the ground equilibrium temperature to determine which of the second set of liquid flow rates provides greatest heat absorption capacity at the lowered input temperature level, and
the design module is further configured to:
(iv) conduct an additional heat rejection capacity test, including comparing the liquid's input temperature and return temperature at the raised input temperature level and at whichever of the first set of liquid flow rates is determined to provide greatest heat rejection capacity at the raised input temperature level; and
(v) conduct an additional heat absorption capacity test, including comparing the liquid's input temperature and return temperature at the lowered input temperature level and at whichever of the second set of liquid flow rates is determined to provide greatest heat absorption capacity at the lowered input temperature level.

69. The system of claim 68, wherein the design module is further configured to:
(vi) conduct a first additional thermal recovery test after conducting the heat rejection capacity test but before conducting the additional heat rejection capacity test; and
(vii) conduct a second additional thermal recovery test after conducting the heat absorption capacity test but before conducting the additional heat absorption capacity test.

70. The system of claim 69, wherein the design module is configured to conduct the additional heat rejection capacity test before the thermal recovery test.

71. The system of claim 69, wherein the design module is configured to conduct the additional heat absorption capacity test before the thermal recovery test.

72. The system of claim 69, wherein
when conducting the first additional thermal recovery test, the design module neither adds heat to the liquid nor removes heat from the liquid, and the design module measures a first length of time for the input temperature and the return temperature to approximate the ground equilibrium temperature,
when conducting the thermal recovery test, the design module removes heat from the liquid in a manner that simulates a supplemental heat exchanger, and the design module measures a second length of time for the input temperature and the return temperature to approximate the ground equilibrium temperature, and
when conducting the second additional thermal recovery test, the design module neither adds heat to the liquid nor removes heat from the liquid, and the design module measures a third length of time for the input temperature and the return temperature to approximate the ground equilibrium temperature.

73. The system of claim 39, wherein one of the determined heat rejection characteristics is how many units of heat energy per unit time the ground heat exchanger can reject to the physical environment.

74. The system of claim 39, wherein one of the determined heat absorption characteristics is how many units of heat energy per unit time the ground heat exchanger can absorb from the physical environment.

75. The system of claim 39, wherein the ground heat exchanger is a buried closed loop heat exchanger.

76. The system of claim 39, wherein the design module is further configured to:
(iv) display heat rejection characteristics and heat absorption characteristics of the ground heat exchanger in the physical environment; and
(v) display thermal recovery characteristics of the physical environment.

77. The system of claim 76, wherein both the display of heat rejection characteristics and heat absorption characteristics of the ground heat exchanger in the physical environment and the display of thermal recovery characteristics of the physical environment are in real time.

78. A design module for collecting information to be used in designing a geothermal heat exchange system, the design module comprising:
(a) a source loop connected to heating equipment and cooling equipment and including a source liquid temperature sensor;
(b) a load loop connected to a ground heat exchanger in a physical environment, the load loop including an input liquid temperature sensor and a return liquid temperature sensor;
(c) a mixing valve connected to the source loop and the load loop and configured to selectively mix source liquid from the source loop with return liquid from the ground heat exchanger to supply input liquid to the ground heat exchanger; and
(d) a control system that includes:
(i) a testing controller,
(ii) a source loop controller configured to (A) selectively activate the heating equipment or the cooling equipment, (B) receive a source liquid temperature value from the source liquid temperature sensor, and (C) adjust operation of the heating equipment or the cooling equipment to conform the source liquid temperature value to a source liquid temperature set point, and
(iii) a mixing valve controller configured to (A) receive the source liquid temperature value from the source liquid temperature sensor, (B) receive a return liquid temperature value from the return liquid temperature sensor, and (C) adjust the mixing valve to supply input liquid to the ground heat exchanger.

79. The design module of claim 78, wherein
the source loop further includes a source loop variable speed pump, and
the source loop controller is further configured to (D) adjust operation of the source loop variable speed pump to conform a source liquid flow rate value to a source liquid flow rate set point.

80. The design module of claim 78, wherein
the load loop further includes a load loop variable speed pump, and
the control system further includes:
(iv) a load loop controller configured to adjust operation of the load loop variable speed pump to conform a load liquid flow rate value to a load liquid flow rate set point.

81. The design module of claim 78, further comprising:
(e) a human-machine interface configured to display information to a user and to permit the user to access the control system.

82. The design module of claim 81, wherein the human-machine interface is configured to permit the user to access the control system in one or more of the following manners: manually activate the heating equipment or the cooling equipment, set the source liquid temperature set point, set an input liquid temperature set point, set one or more flow rate set points, select one or more tests to be conducted by the testing controller, determine a sequence of tests to be conducted by the testing controller, and specify a time duration for one or more tests to be conducted by the testing controller.

83. The design module of claim 78, wherein the mixing valve comprises a proportioning valve.

84. The design module of claim 8, wherein the mixing valve comprises one or more injection valves.

85. The design module of claim 78, wherein the mixing valve is configured to supply input liquid to the ground heat exchanger that is a mix of 100% return liquid and 0% source liquid.

86. The design module of claim 78, wherein the control system's testing controller is configured to conduct a heat rejection capacity test to determine heat rejection characteristics of the ground heat exchanger in the physical environment.

87. The design module of claim 86, wherein the control system's testing controller is further configured to conduct an additional heat rejection capacity test to determine additional heat rejection characteristics of the ground heat exchanger in the physical environment.

88. The design module of claim 87, wherein the control system's testing controller is further configured to conduct a thermal recovery test between the heat rejection capacity test and the additional heat rejection capacity test to determine thermal recovery characteristics of the physical environment.

89. The design module of claim 78, wherein the control system's testing controller is configured to conduct a heat absorption capacity test to determine heat absorption characteristics of the ground heat exchanger in the physical environment.

90. The design module of claim 89, wherein the control system's testing controller is further configured to conduct an additional heat absorption capacity test to determine additional heat absorption characteristics of the ground heat exchanger in the physical environment.

91. The design module of claim 90, wherein the control system's testing controller is further configured to conduct a thermal recovery test between the heat absorption capacity test and the additional heat absorption capacity test to determine thermal recovery characteristics of the physical environment.

92. The design module of claim 78, wherein the control system's testing controller is configured to conduct a thermal recovery test to determine thermal recovery characteristics of the physical environment.

93. The design module of claim 92, wherein the thermal recovery test comprises a hydrogeologic recovery test.

94. The design module of claim 92, wherein the thermal recovery test comprises an atmospheric recovery test.

95. The design module of claim 78, wherein the control system's testing controller is configured to conduct a heat rejection capacity test, a heat absorption capacity test, and a thermal recovery test after the heat rejection capacity test but before the heat absorption capacity test.

96. The design module of claim 78, wherein the control system's testing controller is configured to conduct a heat absorption capacity test, a heat rejection capacity test, and a thermal recovery test after the heat absorption capacity test but before the heat rejection capacity test.

97. The design module of claim 78, wherein the control system's testing controller is configured to conduct a heat rejection capacity test, then a first thermal recovery test, then an additional heat rejection capacity test, then a second thermal recovery test, then a heat absorption capacity test, then a third thermal recovery test, then an additional heat absorption capacity test.

98. The design module of claim 97, wherein the first thermal recovery test comprises a first hydrogeologic recovery test, the second thermal recovery test comprises an atmospheric recovery test, and the third thermal recovery test comprises a second hydrogeologic recovery test.

99. The design module of claim 78, wherein the control system's testing controller is configured to conduct a heat absorption capacity test, then a first thermal recovery test, then an additional heat absorption capacity test, then a second thermal recovery test, then a heat rejection capacity test, then a third thermal recovery test, then an additional heat rejection capacity test.

100. The design module of claim 78, wherein the ground heat exchanger is part of an existing geothermal heat exchange system, and the control system's testing controller is configured to conduct an excess capacity heat exchange test.

101. A method comprising:
(a) using a design module to circulate liquid through a ground heat exchanger in a physical environment, the liquid having an input temperature entering the ground heat exchanger and a return temperature returning from the ground heat exchanger;
(b) circulating liquid through the ground heat exchanger at a first flow rate,
(c) holding the liquid's input temperature or return temperature at a first temperature level that is above a ground equilibrium temperature,
(d) measuring whichever of the liquid's input temperature or return temperature is not being held at the first temperature level, and
(e) comparing the liquid's input temperature and return temperature over time to determine heat rejection characteristics of the ground heat exchanger in the physical environment.

102. The method of claim 101, wherein the heat rejection capacity test further includes:
(f) circulating the liquid through the ground heat exchanger at a second flow rate that differs from the first flow rate, and
(g) repeating steps (c), (d), and (e).

103. The method of claim 102, wherein one of the determined heat rejection characteristics is whether the first flow rate or the second flow rate provides greater heat rejection capacity with the liquid's input temperature or return temperature at the first temperature level.

104. The method of claim 101, wherein the heat rejection capacity test further includes:
(f) changing the liquid's input temperature or return temperature to a second temperature level that is above the ground equilibrium temperature and differs from the first temperature level,
(g) holding the liquid's input temperature or return temperature at the second temperature level,
(h) measuring whichever of the liquid's input temperature or return temperature is not being held at the second temperature level, and repeating step (e).

105. The method of claim 104, wherein the heat rejection capacity test further includes:
(j) circulating the liquid through the ground heat exchanger at a second flow rate that differs from the first flow rate after step (e) but before step (f), and
(k) repeating steps (c), (d), and (e) before proceeding to step (f).

106. The method of claim 105, wherein the heat rejection capacity test further includes:
(l) circulating the liquid through the ground heat exchanger at the second flow rate after step (i), and
(m) repeating steps (g), (h), and (i).

107. The method of claim 104, wherein the heat rejection capacity test further includes:
(j) changing the liquid's input temperature or return temperature to a third temperature level that is above the ground equilibrium temperature and differs from the first temperature level and the second temperature level,
(k) holding the liquid's input temperature or return temperature at the third temperature level,
(l) measuring whichever of the liquid's input temperature or return temperature is not being held at the third temperature level, and
(m) repeating step (e).

108. The method of claim 101, wherein the heat rejection capacity test includes:
(c) holding the liquid's input temperature at the first temperature level, and
(d) measuring the liquid's return temperature.
